(19) United States
(12) Patent Application Publication
(10) Pub. No.: US 2025/0244294 A1
(43) Pub. Date: Jul. 31, 2025

(54) SYSTEMS AND METHODS FOR DETECTING MISALIGNMENT IN BATTERY CELLS USING ULTRASOUND

(71) Applicant: TITAN ADVANCED ENERGY SOLUTIONS, INC., Salem, MA (US)

(72) Inventors: Georgios KAPODISTRIAS, Reading, MA (US); Vahidreza ALIZADEH, Billerica, MA (US); Mohammadreza KARI, Middleton, MA (US); Andrew CANNON, Marblehead, MA (US); Esteban GARCIA-TAMAYO, Medellin (CO); Christian Todd JENSEN, Cambridge, MA (US); Trevor-Max Jensen SMITH, Charlestown, MA (US); Nemanya SEDOGLAVICH, Wenham, MA (US); Shawn D. MURPHY, Wenham, MA (US)

(21) Appl. No.: 19/037,088

(22) Filed: Jan. 25, 2025

Related U.S. Application Data
(60) Provisional application No. 63/625,700, filed on Jan. 26, 2024.

(51) Int. Cl. G01N 29/04; G01N 29/22; G01N 29/265; G01N 29/27; G01N 29/28; G01N 29/44; G08B 21/18; H01M 10/04; H01M 10/42

(52) U.S. Cl. CPC G01N 29/043; G01N 29/048; G01N 29/221; G01N 29/265; G01N 29/27; G01N 29/28; G01N 29/4418; G08B 21/182; H01M 10/04; H01M 10/4285; G01N 2291/0231; G01N 2291/106

(57) ABSTRACT

An inspection system and method for inspecting a battery cell are disclosed. The system interrogates a battery cell by transmitting ultrasound signals into the battery cell at target points, detects ultrasound reflected from the battery cell at each of the target points, and generates response signals from the detected ultrasound at each of the target points. The system also detects one or more misaligned layers within the cell based on the response signals for each target point and calculates a misalignment score based upon the response signals. The misalignment score indicates a level of layer misalignment of each battery cell. Additionally, the inspection system can perform an action associated with each battery cell based upon the misalignment score, such as placing each battery cell in a pass bin or a fail bin or notifying an operator via a message, in examples.

### CROSS-REFERENCE TO RELATED APPLICATION(S)

This application claims benefit of and priority under 35 U.S.C. § 119(e) to and is a non-provisional of U.S. Provisional Application No. 63/625,700, filed Jan. 26, 2024, entitled “Systems and Methods for Detecting Misalignment in Lithium-Ion Batteries Using Ultrasound,” which is incorporated by reference herein in its entirety.

### FIELD

The present disclosure relates generally to inspection of energy storage devices (e.g., battery cells), and more particularly, to detection of misalignment in battery cells (e.g., lithium-ion batteries) using ultrasound.

### BACKGROUND

Battery cells, such as lithium-ion battery cells, are generally constructed as follows. The cells include alternating positive and negative electrode layers (cathode and anode layers, respectively), with a non-conductive separator layer between each anode/cathode pair to form an anode/separator/cathode assembly (“electrode assembly”). Each electrode assembly, or group of electrode assemblies, is then immersed in an electrolyte. Thus, each anode, cathode and separator can form a surface of the battery cell.

Rechargeable lithium-ion battery cells generally have three types. In a first example, a cylindrical battery cell, a continuous assembly is successively wound around a starting center point and onto itself. The resulting assembly is then included within a cylindrical metal case or housing, and the electrolyte is added to the housing. In a second example, a prismatic battery cell, multiple assemblies comprising anode, cathode and separator elements are formed, cut, and then stacked on top of one another. The stack of assemblies is enclosed in a pouch or bag, an electrolyte is added to the bag, and the bag is placed in a substantially rectangular housing. In a third example, a pouch battery cell includes stacked assemblies as in the prismatic cells, but the pouch battery cell configuration can have large rectangular dimensions as compared with the cells thickness. The stacked assemblies are included within the battery pouch, electrolyte is added to the pouch, but typically no housing is used.

The lithium-ion battery cells are manufactured in multiple stages. These stages include layer construction, cell assembly/electrode assembly, formation (also known as electrolyte filling and wetting or soaking), cell activation and post-activation. A summary of each stage is included below.

In the layer construction phase, the earliest phase, different metal foil substrate materials are selected for the anode and cathode layers, and a non-conductive polymer (or layers of polymers) is selected for the separator layer. Copper and aluminum films can be selected for the anode and cathode layers, respectively. A “slurry” coating solution is prepared that includes chemical components such as active materials, a polymer binder, and conductive agents and other additives. The components are mixed together to form the slurry. The metal foil substrates are coated with the slurry to create metal film electrodes with desired properties. The metal film electrodes are then baked in an oven, rolled and compressed under high pressure (also known as calendaring) to promote adhesion, uniformity and to improve porosity, and then cut into strips of a desired shape in accordance with the design/type of the battery cell.

Regardless of battery cell type (prismatic, pouch, or cylindrical), batteries are typically constructed by precisely aligning layers of anodes, separators, and cathodes. For example, pouch and some prismatic cells are made by stacking multiple successive anode-separator-cathode layers on top of each other. These layers are precisely cut to a specific size and shape and aligned to ensure that each anode and cathode are isolated to avoid internal shorts. Similarly, most prismatic and all cylindrical cells are made by laying down an anode layer, a separator, and a cathode layer and then rolling them to conform to the desired shape (rectangular or cylindrical).

The cell assembly/electrode assembly stage includes winding or stacking of an anode, a separator, and a cathode in a “sandwich” configuration. The resulting assembly is then formed into the desired battery cell type. Contacts can then be added to the one or more assemblies.

The assemblies/battery cells are then packaged or otherwise arranged into the desired battery form factor, filled with an electrolyte, charged slowly to activate the cells, and then tested over a period of days or weeks for proper operation and for indicia of defects. Errors during the cell assembly process (e.g., stacking, rolling, and/or enclosing) can result in misaligned layers, which can result in bent anodes that could come in contact with other layers and/or cause micro-shorts that affect the performance of the battery, in examples.

Existing methods for detecting defects in battery cells can employ either non-destructive or destructive methods. A standard method to detect misaligned layers is to perform an x-ray based computed tomography (CT) scan. CT scans provide non-destructive testing of batteries to directly or indirectly determine defects such as misaligned layers. Another method is to destructively open a finished battery cell (e.g., a battery teardown) and look closely for evidence of misalignment.

The existing battery cell inspection methods for detecting misaligned layers in battery cells have limitations. In the CT scans, the target battery cell must be removed from the manufacturing/production line and placed in a separate CT system for scanning. The CT systems can accurately detect many defects, but this requires the use of high resolution scans. Because the scanning time increases with increasing scan resolution, each high-resolution scan can take up to an hour or more. Moreover, the images produced by the CT systems are typically gray-scale images, which can have low contrast. These low-contrast images can make it difficult for operators to distinguish defects from scattered radiation and artifacts, in examples. Because CT systems use x-rays, personnel exposure to x-rays must also be minimized and monitored. Moreover, the CT systems are expensive to purchase and operate.

The battery teardown method has its own set of limitations. In addition to the problem of full destruction of the battery cell under test, this technique is also very time consuming, and there is a substantial risk that a misalignment defect can be accidentally introduced during the teardown. Finally, the process requires trained personnel to perform the teardown in special laboratory areas that can protect people from coming into contact with battery chemicals.

Thus, there is an unmet need for battery cell inspection systems that can detect layer misalignment defects in shorter time than and with similar accuracy than existing inspection methods and can also inspect each and every battery cell throughout the stages of the manufacturing process without the need to remove the battery cells from the production line.

Embodiments of the disclosed subject matter may address one or more of the above-noted needs, problems, and/or disadvantages, among other things.

### SUMMARY

Embodiments of the disclosed subject matter can provide improved detection of layer misalignment in battery cells, in particular, by using ultrasound to interrogate battery cells. Ultrasound is a non-destructive testing (NDT) method that offers some key advantages. For example, not only can ultrasound penetrate materials and detect internal flaws (e.g., cracks, voids, layer misalignment, and foreign inclusions), but it is also highly sensitive, allowing the detection of minute defects and discontinuities in materials that may not be visible to the naked eye. In addition, ultrasound is a real-time NDT method that can provide quantitative information (e.g., depth and size of defects) and material properties (e.g., attenuation and speed of sound) without causing damage, thereby reducing the need for costly teardowns. Ultrasound interrogation is also faster than CT scan methods and enables real-time detection of defects such as layer misalignment, without the need to remove the battery cells from the manufacturing/production line and place them in a separate scanning system, as in the CT systems. This saves on cost. Finally, ultrasound is a non-ionizing method, making it safe for both the operator and the environment, which further reduces the operating costs.

In one or more embodiments, an inspection system can perform one or more ultrasound interrogation sessions of one or more battery cells. The inspection system can include ultrasound transducers, a transport module, a controller, a signal drive and acquisition system (SDM), and a processing system. The ultrasound transducers can be configured to: (i) receive ultrasound excitation signals; (ii) transmit ultrasound at one or more target points of each battery cell, in response to receiving the excitation signals; (iii) detect ultrasound reflected from each battery cell in response to the transmission of the ultrasound at the one or more target points; and (iv) generate response signals based upon the detected ultrasound at the target points. The transport module can be configured to move each battery cell relative to the ultrasound transducers and/or to move the ultrasound transducers relative to each battery cell, during the ultrasound interrogation of each battery cell. The SDM can be configured to generate and send the excitation signals to the ultrasound transducers, to receive the response signals associated with the detected ultrasound at the target points from the ultrasound transducers, and to forward the response signals to the controller. The controller can create a hyper pixel for each of the target points. Each hyper pixel can include a representation of the response signals generated for a respective one of the target points. The processing system can be configured to (i) receive the response signals and the hyper pixels from the controller; (ii) detect one or more misaligned layers in each cell and a misalignment type for each of the one or more misaligned layers based upon the response signals or the hyper pixels; and (iii) calculate a misalignment score based upon the response signals or the hyper pixels.

The misalignment score can indicate a level of misalignment of the one or more layers in the respective battery cell. In some embodiments, the inspection system can additionally perform an action associated with each battery cell based upon the misalignment score.

In one or more embodiments, a method can comprise interrogating each battery cell by transmitting ultrasound signals into each battery cell at one or more target points. The method can further comprise detecting ultrasound reflected from the battery cell at each of the target points. The method can also comprise generating response signals from the detected ultrasound at each of the target points. The method can further comprise creating a hyper pixel for each target point, where each hyper pixel includes a representation of the response signals at each target point. The method can also comprise detecting one or more misaligned layers and a misalignment type for each of the one or more misaligned layers in each cell, based upon the response signals or the hyper pixels. The method can also comprise calculating a misalignment score based upon the response signals or the hyper pixels for each target point. The misalignment score can indicate a level of misalignment of the one or more layers in each battery cell. In some embodiments, the method can further comprise performing an action associated with each battery cell based upon the misalignment score. In some embodiments, the method can be for operating an inspection system that performs one or more ultrasound interrogation sessions on one or more battery cells

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the disclosed subject matter. The features of the disclosed subject matter will best be understood from the following detailed description and example embodiments thereof selected for the purposes of illustration and shown in the accompanying drawings in which:

FIGS. 1A-1D show typical stacking and winding of battery electrodes, derived from Wu et al., “Good Practices for Rechargeable Lithium Metal Batteries,” Journal of The Electrochemical Society, 2019, 166(16): pp. A4141-49;

FIG. 2 is a perspective view of an exemplary prismatic battery cell with a housing, where the view shows front, back, left and right sides of the cell, and shows areas of the cell and target points included within and superimposed upon the areas, and where the inspection system is configured to transmit ultrasound into the target points during the interrogation of the cell;

FIGS. 3A-3D depict left side views of prismatic cells with their housing removed, where the views show only a bottom corner of the cells, and where: FIG. 3A shows layers within the cell that exhibit no misalignment; FIG. 3B shows a misaligned cathode layer that has shifted upwards relative to other layers in the cell and is exposed at its top; FIG. 3C shows a misaligned cathode layer that has shifted downwards relative to other layers in the cell, and is exposed at its bottom; and FIG. 3D shows a misaligned anode layer that is folded and an adjacent cathode layer is exposed as a result;

FIGS. 4A-4D are magnified computed tomography (CT) scan images of different battery cells, with only a bottom corner portion of a battery cell shown in each, where FIGS. 4A-4D correspond to FIGS. 3A-3D, respectively;

FIGS. 5A and 5B depict a long layer misalignment in a single anode layer of a prismatic battery cell with its housing removed, where FIG. 5A is a left side view of the cell and FIG. 5B is a front view of the cell;

FIG. 6 is a simplified schematic diagram of an inspection system according to one or more embodiments of the disclosed subject matter, where the system is located at a customer facility and is configured to determine a level of misalignment of battery cells, the system includes non-contact ultrasound transducers for interrogating the cells with ultrasound, and the system interrogates the battery cells while the cells and the ultrasound transducers are immersed in an electrically non-conductive fluid;

FIG. 7 is a simplified schematic diagram of another inspection system according to one or more embodiments of the disclosed subject matter, where a data repository and a processing system of the inspection system are instead located on a remote network at a service provider;

FIG. 8 is a simplified schematic diagram of yet another inspection system according to one or more embodiments of the disclosed subject matter, where the system is located at a customer facility, and the system uses contact transducers for interrogating battery cells with ultrasound;

FIGS. 9A-9C are simplified schematic diagrams depicting exemplary configurations of transducer modules in the inspection systems of FIGS. 6 and 7, according to one or more embodiments of the disclosed subject matter;

FIGS. 10A-10C are simplified schematic diagrams depicting exemplary ultrasound transducers that can be employed in an inspection system, according to one or more embodiments of the disclosed subject matter;

FIG. 11 is a simplified schematic diagram illustrating aspect of an inspection system according to the configuration of FIG. 7, where the diagram shows more detail for an enclosure of the system;

FIG. 12 is a process flow diagram for aspects of a method of operation of the inspection system of FIG. 7, where the process flow diagram illustrates how the system performs an ultrasound interrogation of each battery cell and calculates a misalignment score for each battery cell in response to the interrogation;

FIG. 13 is a process flow diagram providing further detail for aspects of the method of FIG.

12, in particular, with respect to performing the ultrasound interrogation of each battery cell in an interrogation zone of the enclosure;

FIG. 14 is a process flow diagram providing further detail for aspects of the method of FIG. 12, in particular, with respect to calculating a misalignment score;

FIG. 15A and 15B are normalized magnitude versus frequency and phase versus frequency plots, respectively, that show a modelled response of ultrasound reflected from a 0.01 millimeter (mm) thick copper layer in a housing (0.75-mm wall thickness) immersed in an electrically non-conductive fluid;

FIG. 16A shows: on the left, a section of aluminum housing, into which an interrogation system transmits ultrasound; on the top right, a time domain plot of an ultrasound response signal obtained by the system; and, on the bottom right, a transformed version of the time domain signal in the frequency domain;

FIG. 16B shows: on the left, a section of aluminum housing, followed by alternating, non-misaligned anode and cathode layers to the right of the housing, into which an interrogation system transmits ultrasound; on the top right, a time domain plot of an ultrasound response signal obtained by the interrogation system; and, on the bottom right, a transformed version of the time domain signal in the frequency domain;

FIG. 16C shows: on the left, a section of aluminum housing, followed immediately to the right by a “short misalignment” anode layer, followed by alternating, non-misaligned cathode and anode layers to the right of the misaligned anode layer, into which the interrogation system transmits ultrasound; on the top right, a time domain plot of an ultrasound response signal obtained by the interrogation system; and, on the bottom right, a transformed version of the time domain signal in the frequency domain;

FIG. 16D shows: on the top, a composite of the time domain plots of the ultrasound response signals in FIGS. 16A-16C; and on the bottom, a transformed version of the composite time domain signal in the frequency domain;

FIG. 17A illustrates a selection of ultrasound beam width and scan step size for ultrasound transducers in an inspection system, according to one or more embodiments of the disclosed subject matter, where the beam width selection can be associated with optimizing the detection of misaligned layers within the cell;

FIG. 17B illustrates a configuration for interrogation, where a delay line can be placed between a face of a contact ultrasound transducer and a surface of a battery cell, for example, for adjusting the location of a focal zone within the cell;

FIG. 18A is an image resulting from an ultrasound scan of a top portion of a battery cell, where the image was taken from a front of a prismatic battery cell having no misaligned layers;

FIG. 18B in an image resulting from an ultrasound scan of a top portion of another battery cell that has misaligned layers, where the scans that resulted in the images were performed to validate results of the inspection system upon the same battery cells;

FIG. 19 is an image resulting from a partial CT scan of a front of a prismatic battery cell, taken during an ultrasound interrogation of the cell by the inspection system, where the image shows a focused ultrasound beam transmitted into the cell, and shows a focal zone within the cell for optimal detection of misaligned layers within the cell;

FIG. 20A shows a calculated/modeled plot of a radiated pressure field within a prismatic battery cell, for an ultrasound beam with a frequency of 5 megahertz (MHZ) transmitted into the cell, where the plot shows that the highest resolution of the ultrasound beam is at a depth that is within the focal zone;

FIG. 20B shows a plot of an on-axis profile of the ultrasound beam in FIG. 20A, where the plot shows that a highest amplitude of the beam is also at a depth within the focal zone;

FIG. 21 shows another plot of the on-axis profile of the beam in FIG. 20B, where the plot additionally includes information regarding placement of the battery cell relative to the focused beam profile to optimize detection of misaligned layers within the cell; and

FIG. 22 depicts a generalized example of a computing environment in which the disclosed technologies may be implemented.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

It will be understood that although terms such as “first” and “second” are used herein to describe various elements, these elements should not be limited by these terms. Rather, these terms are only used to distinguish one element from another element. For example, a first element discussed below may instead be termed a second clement, and similarly, a second element may instead be termed a first element without departing from the teachings of the present disclosure.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise. As used herein, the term “and/or” includes any and all combinations of one or more of the associated listed items. It will be further understood that the terms “includes,” “comprises,” “has,” “including,” “having,” and/or “comprising,” when used in this specification, specify the presence of stated features, integers, steps, operations, elements, and/or components, but do not preclude the presence of addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present, unless explicitly stated otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Introduction

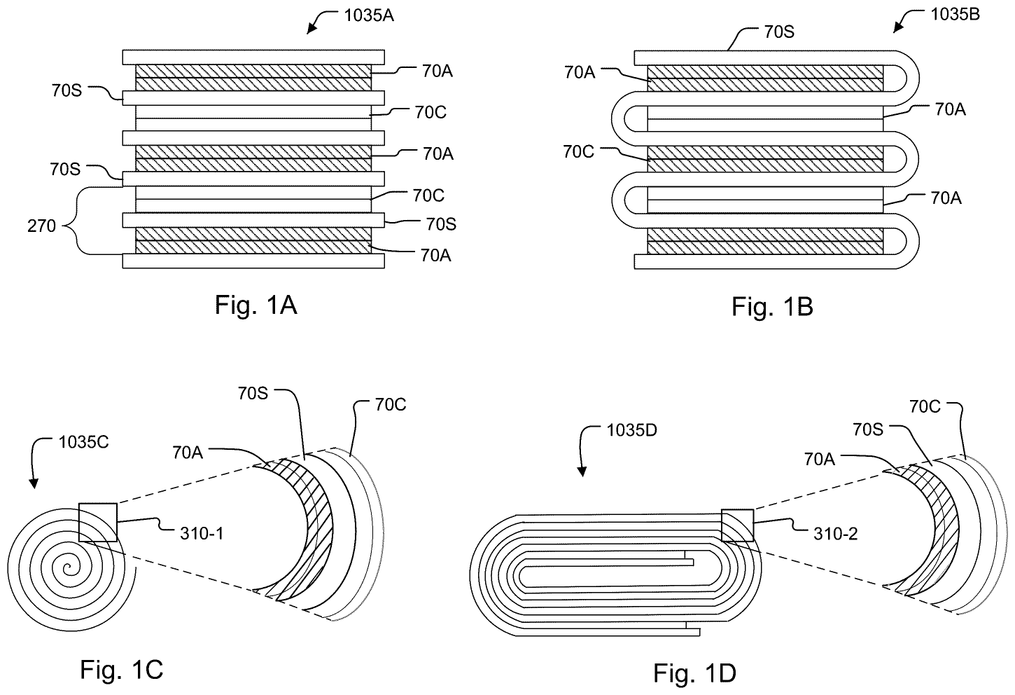

Disclosed herein are systems and methods for detecting misalignment in battery cells using ultrasound, for example, by using an inspection system employing a plurality of ultrasound transducers. In some embodiments, the inspection system can be configured to detect, for example, “superficial” layer misalignments in battery cells. Such superficial layer misalignments can be associated with layers of the cells that occupy a space within the cell that is, for example, at a depth of 30 mm or less from an outside edge of the cell (e.g., a depth that is inward from a front or back side of a housing of a prismatic cell). In some embodiments, the battery cell interrogated by the inspection system can have a configuration similar to that illustrated in FIGS. 1A-1D, although different battery cell configurations are also possible according to one or more contemplated embodiments.

In FIGS. 1A-1D, different types of winding of layers in battery cells are shown, with alternating anode 70A, separator 70S, and cathode 70C layers being placed together to form a “sandwich” of the layers. FIG. 1A shows single sheet stacking of layers to form a battery cell 1035A, while FIG. 1B shows Z-stacking to form a battery cell 1035B. FIG. 1C shows cylindrical winding of layers to form a battery cell 1035C. In FIG. 1C, an area 310-1 of the cell 1035C is selected, and the area 310-1 is expanded to show more detail for the anode 70A, separator 70S, and cathode 70C layers. FIG. 1D shows prismatic winding of the layers to form a battery cell 1035D. In FIG. 1D, an area 310-2 of the cell 1035D is selected, and the area 310-2 is expanded to show more detail for the anode 70A, separator 70S, and cathode 70C layers. In general, the cathode 70C can be formed of and/or comprise a first metal (e.g., copper), the anode 70A can be formed of and/or comprise a different second metal (e.g., aluminum), and the separator 70S can be formed of and/or comprise an electrically non-conductive (e.g., insulating) material. In FIG. 1A, reference 270 indicates an electrode assembly formed from an anode 70A, a separator 70S, and a cathode 70° C. layer.

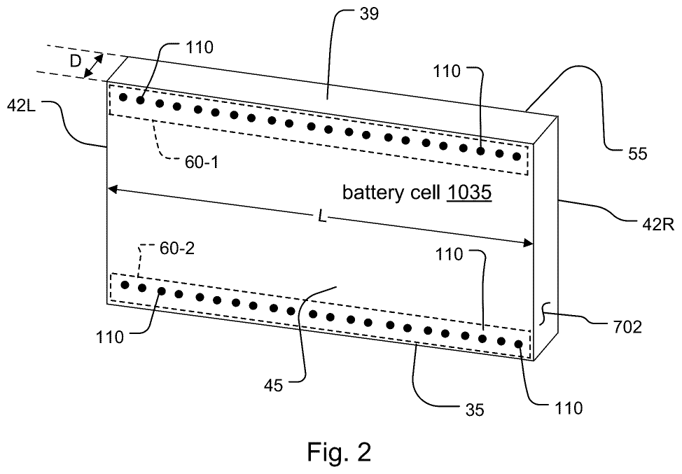

FIG. 2 shows an exemplary prismatic battery cell having a housing 702 (e.g., constructed of and/or comprising aluminum) with a length, L, and a depth, D. In the illustrated example, the cell has a front 45 (facing the viewer), a back 55 that opposes the front 45, a left side 42L, and a right side 42R. A top 39 and a bottom 35 of the cell 1035 are also shown in FIG. 2. Experimentation has shown that misalignment of layers in battery cells nearly always occurs (or can be most readily detected) near the top 39 and bottom 35 of the cells 1035. Thus, in some embodiments, the inspection system can configure target points 110 for detecting layer misalignment in areas 60 of the front 45 and back 55, located near or at least proximal to the top 39 and bottom 35 (e.g., closer to the top or bottom than to a midpoint between the top and bottom). For example, two areas 60-1 and 60-2 are shown at the front 45 in FIG. 2. Each area 60-1, 60-2 includes target points 110. The areas 60 and the target points 110 can be configured by the inspection system prior to an interrogation session, for example, based on the type of battery cell 1035. Area 60-1 is located near the top 39, extends along the length L, and extends downward somewhat from the top 39. Area 60-2 is located near the bottom 35, extends along the length L, and extends upward somewhat from the bottom 35.

In some cases, a battery cell (e.g., prismatic battery cells) can include the majority of their wiring and connections to external contacts near the top 39 thereof. The presence of these connections/components may cause more scattering of the ultrasound transmitted into the cell at area 60-1 than at area 60-2. Thus, in some embodiments, detection of layer misalignment at the top 39 of the battery cell (e.g., at area 60-1) may be performed differently than detection of layer misalignment at the bottom 35 (e.g., at area 60-2). In one example, one type or configuration of ultrasound transducers may be used to interrogate the target points 110 of area 60-1, while a different type or configuration of ultrasound transducers may be used to interrogate the target points 110 of area 60-2.

Alternatively or additionally, a higher excitation frequency (e.g., ˜5 MHz) can be selected for the ultrasound transducer employed for area 60-1, for example, to obtain finer resolution, while a lower excitation frequency (e.g., ˜3 MHz) can be selected for the ultrasound transducers employed for area 60-2. For example, experimentation has shown that an ultrasound beam of approximately 5 MHz can detect misaligned layers in prismatic cells at a depth of approximately 3 mm inwards from a surface of the housing, with high resolution. In another example, an ultrasound beam of approximately 3 MHz can detect misaligned layers in prismatic cells at a depth of as much as 8 mm inwards from a surface of the housing, but with less resolution. In yet another example, an ultrasound beam of approximately 2 MHz can detect misaligned layers in prismatic cells at a depth of as much as 16 mm inwards from a surface of the housing, but the resolution is lesser still.

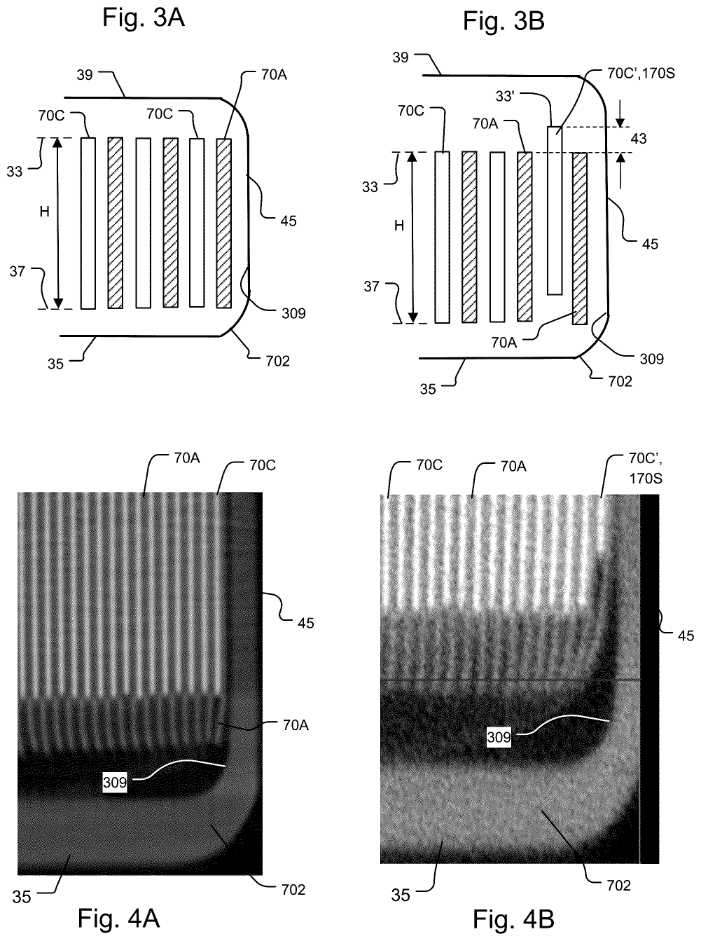

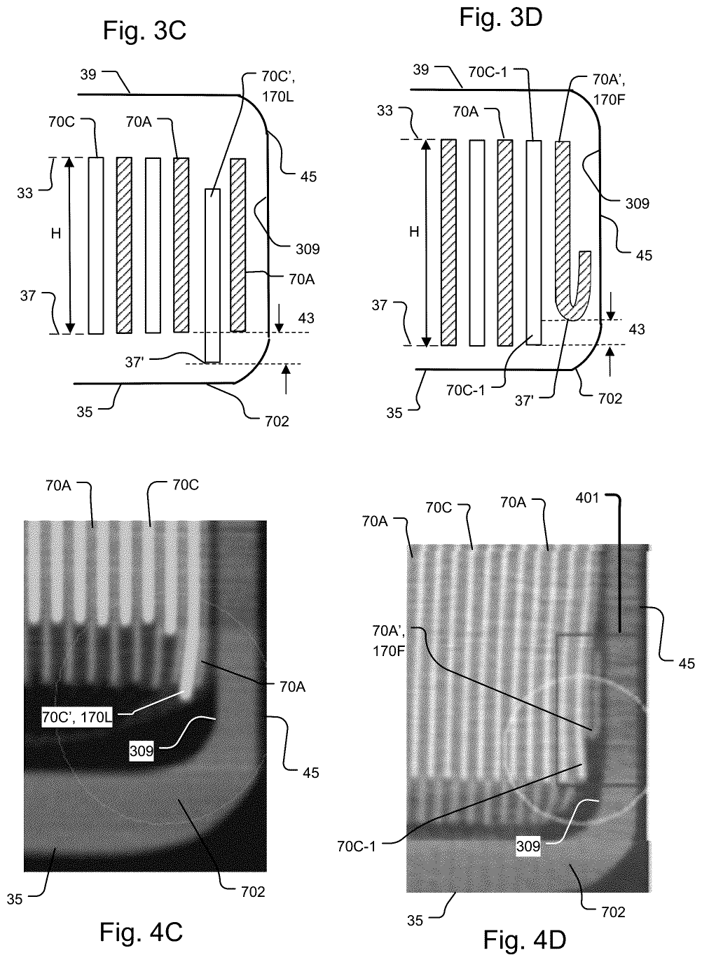

FIGS. 3A-3D each depict a left side view of a prismatic battery cell (e.g., battery cell 1035) with the left side 42 of its housing 702 removed. The drawings show only a portion of the stacked layers 70 within the cell, in particular, only alternating anode layers 70A and cathode layers 70C. In these views, the layers 70 are shown vertically arranged or “stacked” within the cells. In each of FIGS. 3A-3D, a height H, a top 33, and a bottom 37 of the stack are indicated. The layers 70A, 70C are designed to have a same height H. References 33′ and 37′, where applicable, indicate the top and bottom of each misaligned layer 70, respectively. FIGS. 4A-4D are CT scan images corresponding to the drawings of FIGS. 3A-3D, with the cathode layers 70C having a lighter color than the anode layers 70A, since the denser copper material that forms the cathode layers 70C appears brighter in the CT images than the less dense aluminum material that forms the anode layers 70A.

In the illustrated examples, the battery cells are also constructed such that an anode layer 70A is immediately adjacent to an inside surface 309 of the housing 702 (here, adjacent to inside surface 309 of the front 45 of the housing 702). Because of this specific arrangement of the layers, the inspection system can detect misaligned layers, for example, by identifying cathode layers 70C near the front 45 or back 55 sides that are not completely sandwiched or surrounded, along their entire height H, by adjacent anode layers 70A (e.g., located both to the left and to the right of each cathode layer 70C). Alternatively or additionally, in some embodiments, misalignment of at least one of the layers can be detected based at least one of the cathode layers 70C being exposed from the anode layer 70A closest to the inside surface 309.

In more detail, FIG. 3A shows layers 70 within the cell that exhibit no misalignment. Namely, there are no cathode layers 70C detected which have exposed areas along their height H and/or there are no cathode layers 70C detected which have areas along their height H that do not have an adjacent anode layer 70A located to the left and to the right of the respective cathode layer 70C. In contrast, FIG. 3B shows a misaligned cathode layer 70C′ that is shifted upwards with respect to the other layers 70 of the stack. When viewed from the bottom 35 of the cell, the shifted cathode layer 70C′ may be shorter than the other layers (also known as a short layer misalignment 170S). Here, the inspection system detects the short layer misalignment 170S by identifying, at the top 39 of the cell, that a top 33′ of the shifted cathode layer 70C′ has extended upwards beyond the top 33 of the stack. A gap 43 between the top 33′ of the shifted cathode layer 70C′ and the top 33 of the stack is detected, where the shifted cathode layer 70C′ is exposed and/or does not have an adjacent anode layer 70A located both to the left and to the right of the shifted cathode layer 70C′.

FIG. 3C shows a misaligned cathode layer 70C′ that may be longer than the other layers (also known as a long layer misalignment 170L) when viewed from the bottom 35 of the cell 1035. The misaligned cathode layer 70C′ is shifted downward relative to the stack and the bottom 37′ of the shifted cathode layer 70C′ is located downward from the bottom 37 of the stack. A gap 43 between the bottom 37′ of the shifted cathode layer 70C′ and the bottom 37 of the stack is detected near the bottom 35 of the cell 1035. Here, the shifted cathode layer 70C′ does not have an adjacent anode layer 70A located both to the left and to the right of the shifted cathode layer 70C at the location of the gap 43.

FIG. 3D shows a misaligned anode layer 70A′ that is folded (also known as folded layer misalignment 170F) when viewed from the bottom 35 of the cell 1035. The inspection system detects the folding of the folded anode layer 70A′ and also detects a gap 43 between the bottom 37′ of the folded anode layer 70A′ and the bottom 37 of the stack. Because of the folding of the folded anode layer 70A′, its bottom 37′ is located above the bottom 37 of the stack. Adjacent cathode layer 70C-1 is determined to be exposed on its right side and/or is determined to not have an adjacent anode layer 70A located both to the left and to the right of the cathode layer 70C-1, at the location of the gap 43.

FIGS. 4A-4D are magnified images of CT scans of different battery cells, with only bottom corner portions of the images shown. FIG. 4A shows no misaligned layers, corresponding to FIG. 3A. FIG. 4B shows a short layer misalignment 170S for a misaligned cathode layer 70C, corresponding to FIG. 3B. FIG. 4C shows a long layer misalignment 170L for a misaligned cathode layer 70C′, corresponding to FIG. 3C. FIG. 4D shows a folded layer misalignment 170F for a misaligned anode layer 70A′, corresponding to FIG. 3D. Area 401 within the image highlights the location of the folded layer misalignment 170F. In some cases, the size of the layer misalignment in battery cells 1035 can be in a range from about 0.5 mm to about 3 mm, inclusive. In some cases, the tolerance for misalignment may be manufacturer specific and/or depend on cell capacity, cathode chemistry, and/or end-user application. Thus, other values and ranges for detectable layer misalignment are also possible according to one or more embodiments of the disclosed subject matter.

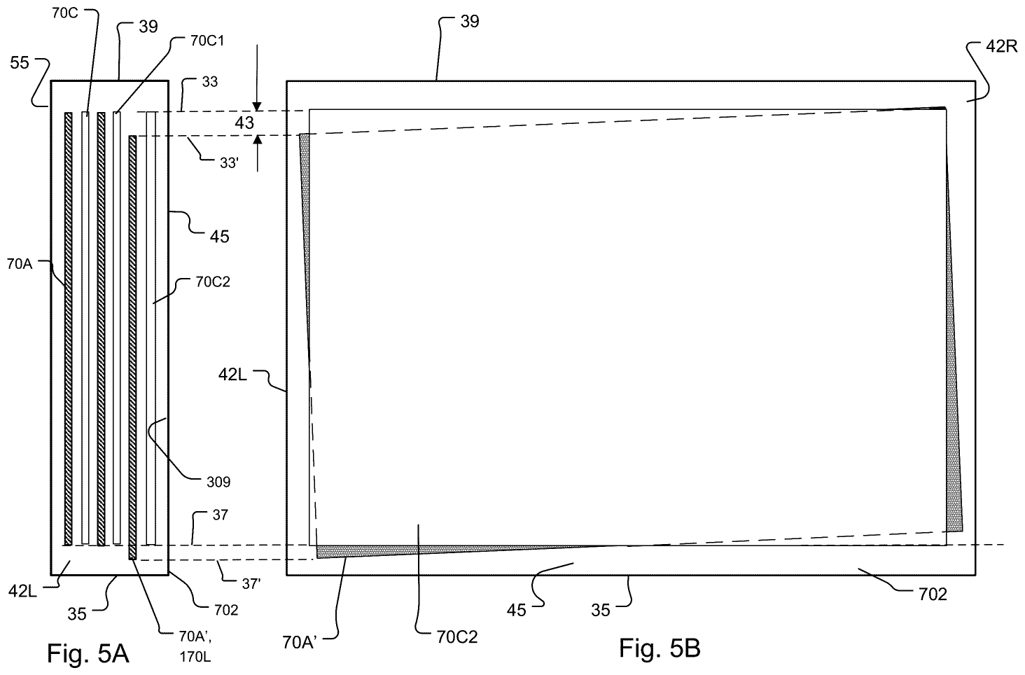

FIGS. 5A-5B depict a single layer, long layer misalignment 170L in a prismatic battery cell with its housing removed. FIG. 5A is a left side view of the cell and FIG. 5B is a front view of the cell 1035. In the illustrated example, the battery cell 1035 is constructed such that a cathode layer 70C2 of the stack is located immediately adjacent to the inside surface 309 of the front side 45 of the cell 1035. In FIGS. 5A-5B, the long layer misalignment 170L (here, a misaligned anode layer 70A′) can be detected as a gap 43 between a bottom 37′ of the misaligned anode layer 70A′ and the bottom 37 of an adjacent, non-misaligned cathode layer 70C1/70C2 in the cell. The non-misaligned cathode layer 70C2 is shown in the foreground in FIG. 5B. While FIG. 5A suggests that the long layer misalignment 170L is shifted or translated downward, FIG. 5B shows that the long layer misalignment 170L is actually shifted downward at a slight angle relative to the other layers 70. Using the techniques in this disclosure, the long layer misalignment 170L and its gap 43 can be detected.

In a similar vein, with reference to FIG. 3B, it can be appreciated that a short layer misalignment 170S can be detected by identifying a gap 43 between a top 33′of a layer associated with a short layer misalignment 170S, and the top 33 of an adjacent layer. Also in a similar vein, with reference to FIG. 3D, a folded layer misalignment 170F can be detected by identifying a folded layer and its adjacent exposed layer. Moreover, a folded electrode assembly misalignment can be detected in a similar fashion as the folded layer misalignment 170F.

### Misalignment Detection System Examples

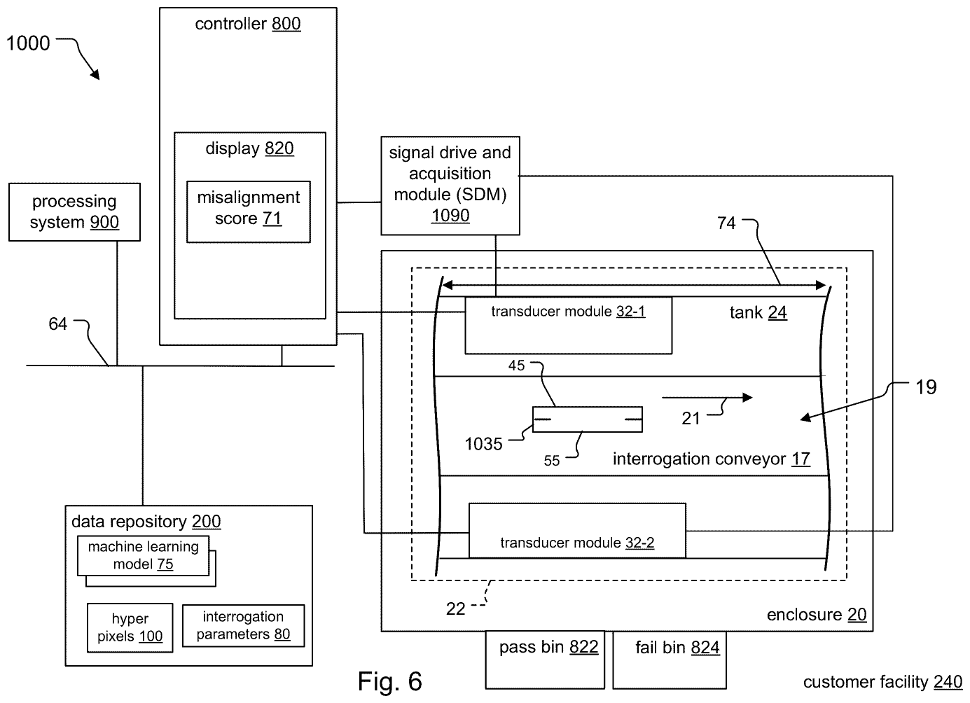

FIG. 6 shows a battery cell inspection system (“inspection system”) 1000 configured to determine a level of misalignment of battery cells 1035, according to one or more embodiments of the disclosed subject matter. The inspection system 1000 can be designed for use in a customer facility 240, for example, a battery cell manufacturing facility that manufactures and/or assembles battery cells. In the illustrated example, system 1000 includes non-contact ultrasound transducers for interrogating the battery cells 1035 with ultrasound, and the system 1000 can interrogate the battery cells while the cells and the ultrasound transducers are immersed in an electrically non-conductive fluid. In the illustrated example of FIG. 6. The inspection system 1000 includes an enclosure 20, a processing system 900, a controller 800, a signal drive and acquisition system (SDM) 1090, and a data repository 200, although additional or different components are also possible according to one or more contemplated embodiments.

In FIG. 6, the enclosure 20 includes a tank 24, a pair of opposing transducer modules 32-1, 32-2, and an interrogation conveyor 17. A battery cell 1035 is shown on the interrogation conveyor 17. The interrogation conveyor 17 can be a component of a transport module 19 of the inspection system 1000, which may also be housed by or otherwise included in the enclosure 20. In some embodiments, the inspection system 1000 may also be provided with separation or storage means, via which battery cells having layer misalignment can be segregated from battery cells having acceptable layer arrangement. In the illustrated example, the separation or storage means can be in the form of bins, e.g., pass bin 822 and fail bin 824 in or associated with enclosure 20; however, other mechanisms for separating and/or storing based on detected misalignment (or alignment) are also possible.

In some embodiments, the controller 800 can include, or at least be operatively coupled to, a display 820. The controller 800 may also be operatively coupled to the transducer modules 32-1, 32-2, for example, via SDM 1090. Each transducer module 32-1, 32-2 can include two or more ultrasound transducers (not shown). In some embodiments, the transducer module 32 can be configured as or comprise transducer arrays. In some embodiments, the transducer modules 32 can also include or otherwise connect to sensors that detect the battery cells 1035. The data repository 200 can include one or more machine learning models 75 and interrogation parameters 80. The interrogation parameters 80 can include the target points 110 and the areas 60 for each type of battery cell 1035 under test.

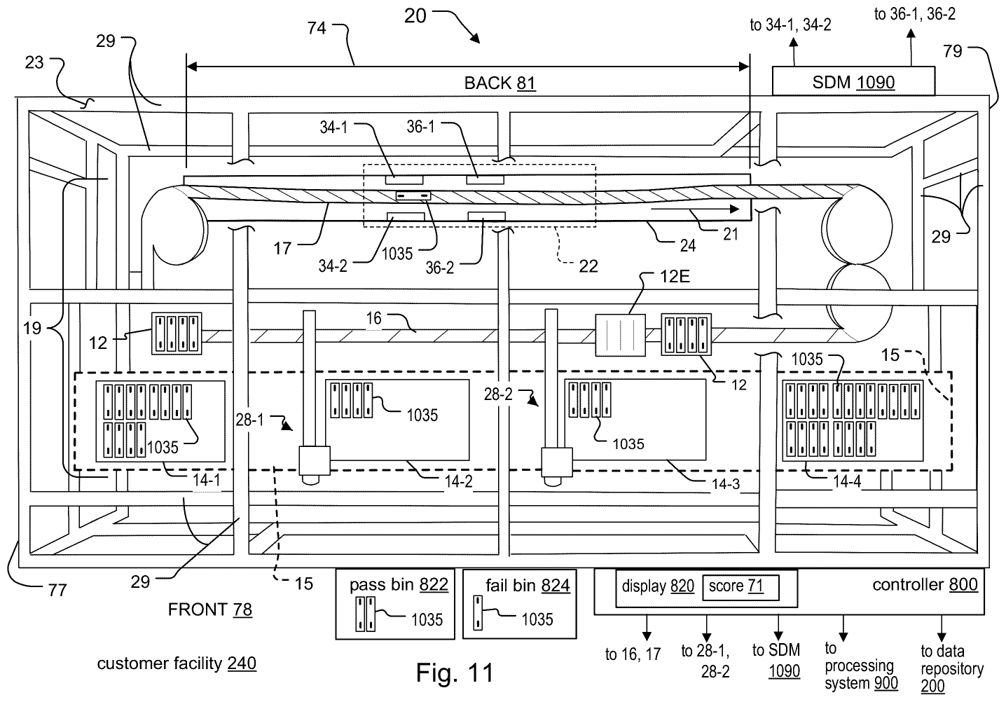

The inspection system 1000 is generally arranged as follows. The processing system 900, the controller 800, and the data repository 200 connect to and communicate over a local area network 64, such as Gigabit Ethernet or other high-speed local network. The controller 800 connects to the SDM 1090 and to the transducer modules 32. The SDM 1090 connects to each of the ultrasound transducers. In FIG. 6, only a portion of the enclosure 20, the tank 24, and the interrogation conveyor 17 are shown and are viewed from a top 23 of the enclosure 20 (e.g., as shown in FIG. 11). The transducer modules 32-1, 32-2 can be included within the tank 24 and can be mounted (or otherwise disposed) on opposing inside walls/surfaces of the tank 24 along its tank length 74. The tank 24 can be filled with an immersive couplant that is electrically non-conductive, such as deionized water. An interrogation zone 22 within the enclosure 20 is also shown. In some embodiments, the interrogation zone 22 can be an area within the enclosure 20 where the battery cells 1035 undergo ultrasound scanning/interrogation. In some embodiments, the transducer modules 32-1, 32-2, a portion of the tank 24 that includes the transducer modules 32-1, 32-2, and a portion of the interrogation conveyor 17 that includes the modules can be disposed within and/or included in the interrogation zone 22.

The inspection system 1000 generally performs one or more interrogation sessions of battery cells 1035 (sequentially or simultaneously) as follows. The machine learning models 75 and the interrogation parameters 80 can be loaded into memory of the controller 800 at startup time of the system 1000. The controller 800 then passes the machine learning models 75 to the processing system 900. The interrogation conveyor 17 can move each battery cell 1035 in an interrogation direction 21 through the tank 24 along its tank length 74, and across the interrogation zone 22. For this purpose, the interrogation conveyor 17 moves each battery cell sequentially through the interrogation zone 22 at a constant rate of speed, during which each battery cell 1035 is immersed in the fluid within the tank 24, and sides of each battery cell 1035 facing the transducer modules 32-1, 32-2 do not come into contact with the transducers 30, 40 of the respective modules. In FIG. 6, the front side 45 of the cell 1035 faces transducer module 32-1, while the back side 55 faces transducer module 32-2. When each battery cell 1035 enters the interrogation zone 22, sensors within (or associated with) the transducer modules 32-1, 32-2 detect each battery cell 1035 and send a signal to the controller 800. In response, the controller 800 instructs the SDM 1090 to send excitation signals to ultrasound transducers within the transducer modules 32-1, 32-2. In the illustrated example, the ultrasound transducers are configured as both ultrasound transmitters and receivers (also known as a pulse-echo configuration of the transducers); however, other configurations for the ultrasound transducers (e.g., as separate emitters and receivers) are also possible according to one or more contemplated embodiments. In response to receiving the excitation signals, the ultrasound transducers transmit ultrasound into the battery cell 1035 and directed at target points 110 located within areas 60 of each cell 1035.

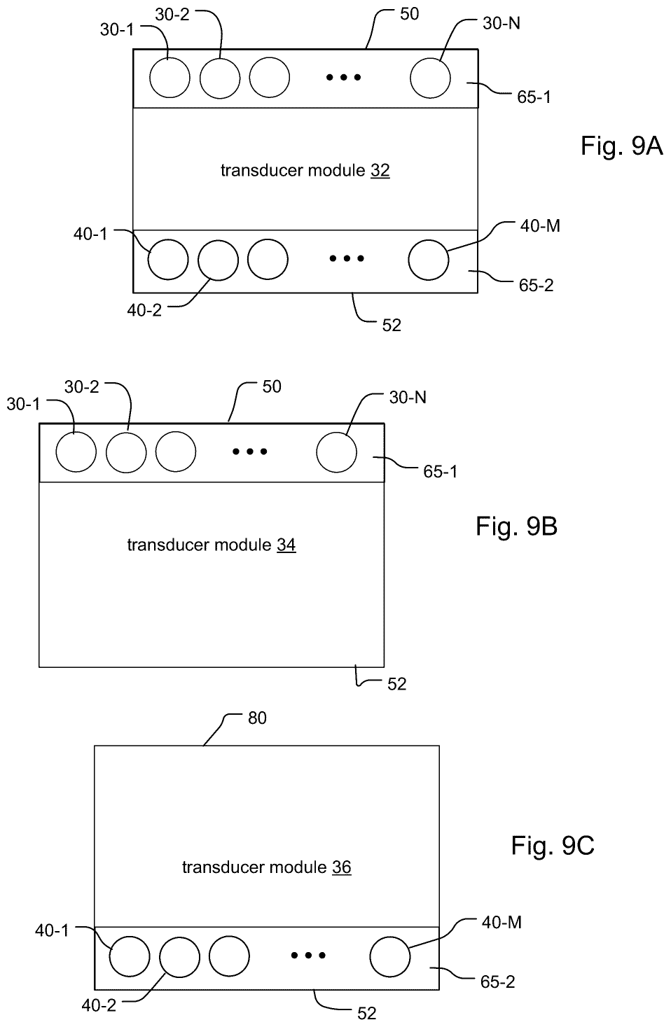

The transducer modules 32-1, 32-2 are configured in the same manner. Transducer module 32-1, for example, includes a first set of ultrasound transducers for interrogating a first area at the front 45 of the cell, where the first area is located near the top 39 of the cell 1035. Transducer module 32-1 also includes a second set of ultrasound transducers for interrogating a second area at the back 55 of the cell, where the second area is located near the bottom 35 of the cell 1035. In this way, the transducer modules 32-1, 32-2 can interrogate both the front 45 and back 55 sides of the battery cell 1035 during an interrogation session, for example, at the areas which have been experimentally shown to detect layer misalignment with the highest likelihood. More detail for configuration of the ultrasound transducers within the transducer modules 32-1, 32-2 is provided below with respect to FIG. 9A.

In FIG. 6, the ultrasound transducers of modules 32-1, 32-2 can detect ultrasound transmitted through and/or reflected by the battery cell 1035, can generate electrical response signals representing the detected ultrasound, and can send the response signals to the SDM 1090. The SDM 1090 can forward the response signals to the controller 800, which collects the response signals for each battery cell 1035 and forwards them to the processing system 900 for analysis. The collection of response signals at each target point 110 is known as a hyper pixel 100. During an interrogation session, one or more ultrasound pulses are transmitted into each target point 110 for at least a first interrogation mode of the ultrasound transducers (here, pulse-echo), and the response signals are collected. This process is repeated for each additional interrogation mode, and the response signals in aggregate for each target point are included in a hyper pixel data structure (“hyper pixel”) for the target point. A representation of the ultrasound signals transmitted at each target point might also be included in the hyper pixel for each target point, or be stored separately from the hyper pixels 100. The processing system 900 then analyzes the response signals and/or the hyper pixels 100 for one or more of the target points 110 to determine characteristics of the battery cells 1035.

The controller 800 or the processing system 900 create the hyper pixels 100 for each battery cell 1035 and store the hyper pixels 100 to the data repository 200. Each hyper pixel 100 can contain one or more values, for example, with value corresponding to a different response signal obtained for the same target point 110 associated with the hyper pixel 100. Each response signal, in turn, can be associated with a different configuration of interrogation parameters 80, for example, selected at the beginning of an interrogation session. In some embodiments, different combinations of selected ultrasound frequencies and interrogation modes (e.g., pulse-echo mode and through-transmission mode) can produce different response signals, which are stored as different response signal values for the same hyper pixel 100.

In some embodiments, the inspection system can analyze the hyper pixels 100 to determine layer misalignment of the battery cells 1035 by extracting or otherwise isolating ultrasound features of the response signals of each hyper pixel 100. The isolated features can then be analyzed in one or more different domains (e.g., a spatial domain, energy domain, resonant or non-resonant domain, a time domain, a frequency domain, a context domain, etc.), in order to characterize one or more features of the response signal. In some embodiments, since isolated ultrasound features of the response signal may correspond with a plurality of different defects associated with a battery target point or target points 110, characterization of the one or more isolated features can further include analyzing each isolated feature of the response signal using different analyzing techniques, each corresponding with one or more of the different defects of the battery target point.

In some embodiments, the inspection system can be configured to analyze each of the response signals for each of the hyper pixels 100. This analysis can include the ability to evaluate ultrasound features of the response signal; classify characteristics of the response signal (e.g., according to defect type); select one or more rules corresponding with separately analyzing ultrasound features of the response signal (e.g., according to defect type); and/or other features of the response signal. For example, the one or more rules can be based on correlation with response signal features generated from hundreds (or possibly thousands) of reference battery cells 1035 of the same type that have been previously evaluated by ultrasound interrogation via the inspection system. The reference battery cells 1035 can then be destructively broken down and shown to deterministically match response signal features with defects (such as layer misalignment) present in the test battery cells. Because known response signals have specific properties when encountering different materials under different conditions, various defects can be inferred. In addition, the response signals can be compared to/correlated with CT scan images of the same battery cells. In this way, validation of the defects and anomalies determined by the inspection system, and calibration of the inspection system, are possible.

Returning to the description of the inspection system 1000, the processing system 900 can then determine a level of misalignment of each battery cell based at least in part upon the response signals for each battery cell 1035. For example, the processing system 900 can calculate a misalignment score 71 based upon the response signals and/or the hyper pixels 100 obtained from each of the target points 110. For example, the misalignment score can be a value between 0 and 1, inclusive, with a threshold value of 0.8 (e.g. indicative of no misalignment). The processing system 900 can use a number of factors when calculating the misalignment score 71. For example, larger gap values 43 for short layer misalignments 170S and long layer misalignments 170L may increase the score, and multiple misaligned layers detected per cell may increase the score as compared to a single layer misalignment detection. When the misalignment score meets or exceeds the threshold value, the processing system can conclude that no misalignment is present and/or that the battery cell has an acceptable, negligible level of misalignment. Alternatively, when the misalignment score is less that the threshold value, the processing system can conclude that misalignment of the layers is present (e.g., a misalignment that may materially affect operation and/or internal components of the cell 1035). Alternatively, in some embodiments, the misalignment score may be a binary value, such as a value of 0 for no misalignment of layers detected, and a value of 1 for any misalignment of layers detected.

In some embodiments, the processing system 900 can send the misalignment score 71 to the controller 800, and the controller may perform an action relating to the misalignment score 71 in response. For example, the controller may simply present the misalignment score 71 for the battery cell 1035 (or multiple battery cells) to the display 820 of the controller 800. An operator of the system (e.g., viewing the score on display 820, or otherwise receiving an indication of the detected misalignment) can then decide what to do with this information. Alternatively or additionally, the controller 800 can instruct a robotic arm of the system 1000 to move the battery cell 1035 to the pass bin 822 or the fail bin 824, based upon the misalignment score 71.

While the processing system 900, data repository 200, controller 800, and SDM 1090 are shown separate from the enclosure 20, it can also be appreciated that the enclosure 20 might also include or otherwise house one or more of these components. Alternatively or additionally, the controller 800 and processing system 900 might be combined into a single computing device to minimize communications overhead and maximize processing speed.

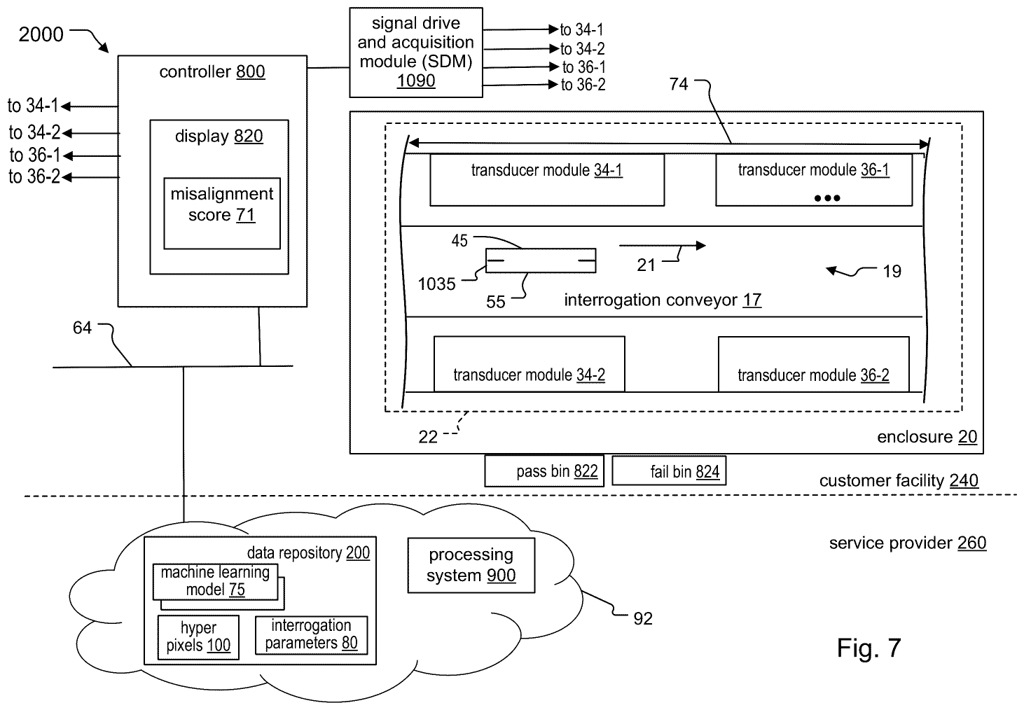

FIG. 7 shows another inspection system 2000 that includes similar components and can operate in a similar fashion as the inspection system 1000 of FIG. 6. However, in contrast to the configuration of FIG. 6, the controller 800, SDM 1090, and enclosure 20 in FIG. 7 are installed at the customer facility 240 and collectively form a test platform of the inspection system 2000, while the data repository 200 and processing system 900 are located in a remote network 92 at a service provider 260. In FIG. 7, the system 2000 also includes two pairs of opposing transducer modules. The first pair includes transducer modules 34-1 and 34-2, while the second pair includes transducer modules 36-1 and 36-2. In the illustrated example of FIG. 7, the front side 45 of the cell 1035 faces transducer modules 34-1 and 36-1, while the back side 55 faces transducer modules 34-2 and 36-2.

The transducer modules 34-1, 34-2 can be configured in the same manner. For example, transducer module 34-1 can include a set of ultrasound transducers for interrogating a first area at the front 45 of the cell, where the first area is located near the top 39 of the cell 1035. Alternatively or additionally, the transducer modules 36-1, 36-2 can also be configured in the same manner, but differently than the transducer modules 34-1 and 34-2. For example, transducer module 36-1 can include a set of ultrasound transducers for interrogating a second area at the front 45 of the cell, where the second area is located near the bottom 35 of the cell 1035. In this way, the transducer modules 34-1, 34-2 and 36-1, 36-2 can collectively interrogate both the front 45 and back 55 sides of the battery cell 1035 during an interrogation session, for example, at the areas which have been experimentally shown to detect layer misalignment with the highest likelihood. Further detail for configuration of the ultrasound transducers within the transducer modules 34-1, 34-2 is provided in FIG. 9B, and further detail for the configuration of the ultrasound transducers within the transducer modules 36-1, 36-2 is provided in FIG. 9C, the descriptions of which are included below.

In FIG. 7, the test platform can use data and processing resources provided by a service provider 260 via the remote network 92. The resources of the remote network 48 can be included as part of a cloud-based computing and storage service, such as Amazon Web Services (AWS), IBM Cloud Services, and Microsoft Cloud Services, in examples. As compared to the inspection system 1000 of FIG. 6, inspection system 2000 in FIG. 7 can employ fewer components installed at the customer premises 240, and the test platforms installed at different customer premises (e.g., similar to premises 240) can access remote data and processing resources that are managed by a common service provider or different service providers. In some embodiments, the remote data and processing resources provided by the service provider 260 for each customer can be isolated/firewalled from one another, and/or can be configured in different ways. In some embodiments, the service provider 260 may provide a similar set of services to all customers as a default, and then tailor the services to each customer based upon their needs.

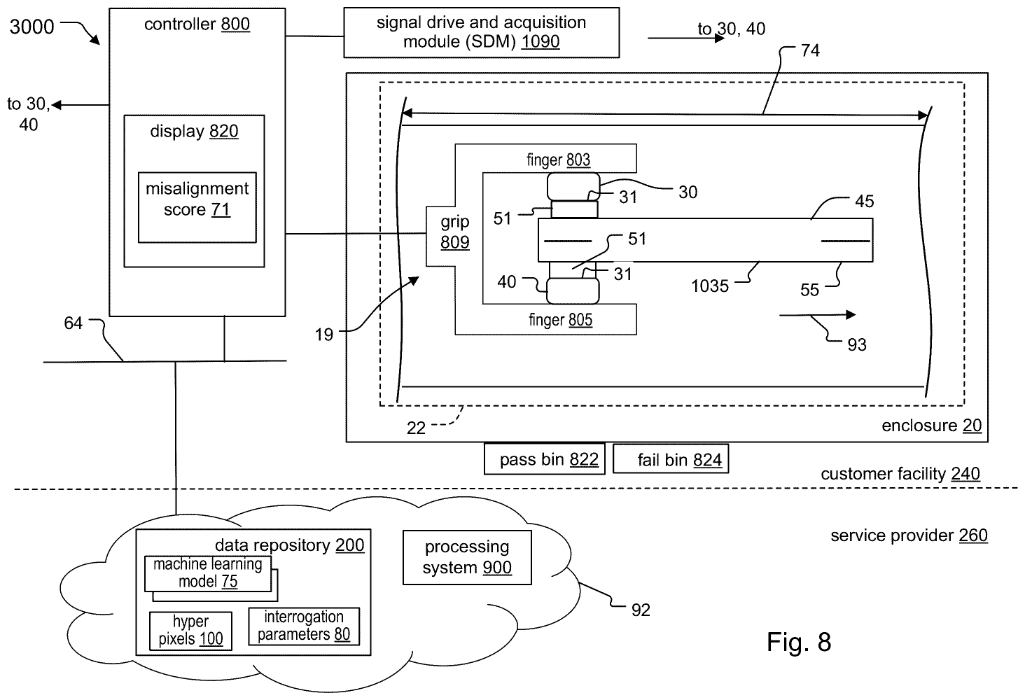

FIG. 8 shows another inspection system 3000 that includes similar components and can operate in a similar fashion as the inspection systems of FIGS. 6-7. However, in contrast to the configuration of FIGS. 6-7, transport module 19 can include a robotic arm with a grip 809 that carries two ultrasound transducers 30, 40. In FIG. 8, only the grip 809 of the robotic arm is shown, although practical embodiments may include additional components for the robotic arm. In the illustrated example, the grip 809 includes two opposing fingers 803, 805 that are laterally arranged with respect to the length, L, of the battery cell 1035. The finger 803 carries transducer 30, and the transducer 30 has a face 31 that faces the front side 45 of the cell. In a similar vein, the finger 805 carries transducer 40, and the transducer 40 has a face 31 that faces the back side 55 of the cell. In FIG. 8, the faces 31 of the ultrasound transducers 30, 40 are in contact with the battery cells 1035 via couplant 51 (e.g., gel or dry couplant). However, in some embodiments, the transducers 30, 40 can be in contact with the battery cells without a couplant located therebetween.

During an interrogation session performed by system 3000, each battery cell 1035 can be fixed in place, and the controller 800 can instruct the transport module 19 to place the ultrasound transducers 30, 40 against the surfaces 45, 55 of the battery cell 1035. The transport module 19 can move the ultrasound transducer 30 to a first of its target points 110 of a first area on the front side 45, while also moving the ultrasound transducer 40 to a first of its target points 110 of a first area on the back side 55. The transport module 19 then moves the ultrasound transducers 30, 40 to each of their remaining target points 110 in a scan direction 93. In some embodiments, the transport module 19 may also be configured to perform interrogation of multiple areas 60 of a battery cell 1035, either at the same time, or sequentially. For this purpose, for example, the transport module 19 might grasp a different ultrasound transducer than the ultrasound transducer and perform an ultrasound scan of target points 110 in a second area, along the scan direction 93.

Alternatively, in some embodiments, the transport module 19 can include two separate robotic arms that each grasp a separate ultrasound transducer 30, 40. The robotic arms can then move their respective transducers 30, 40 to the target points 110 at similar areas located at the front 45 and back 55 of the cell 1035. Alternatively or additionally, in some embodiments, the transport module 19 can include two separate robotic arms that each grasp a separate ultrasound transducer module 32-1 and 32-2. In this way, when the robotic arms move their respective transducer modules 32-1, 32-2 in the scan direction 93, the first and second areas on both sides 45, 55 of the battery cell 1035 can be scanned.

In this contact setup, the inspection system 3000 can employ circular contact transducers. The transducers can be moved by the transport module 19 from one edge of the cell to the other edge of the cell 1035. In some embodiments, the beam diameter can be small to have better resolution, for example, as small as possible. For example, the beam diameter can depend on several parameters, such as but not limited to frequency, aperture size, and/or distance from the transducer. In addition, to have good axial resolution, a higher frequency transducer can be used.

FIG. 9A shows an exemplary configuration of a transducer module 32 that can be used in an inspection system (e.g., inspection system 1000 of FIG. 6). Each transducer module 32 can have a top 50 and a bottom 52, and can include a top transducer array 65-1 located near the top 50 and a bottom transducer array 65-2 located near the bottom 52. The transducer array 65-1 includes two or more ultrasound transducers 30-1, 30-2 . . . 30-N. The array 65-1 and characteristics of its ultrasound transducers 30 (e.g., number N, type, excitation frequency, beam width) can be tailored to the first area of the battery cell 1035 (e.g., 60-1 as shown in FIG. 2). Similarly, transducer array 65-2 can include two or more ultrasound transducers 40-1, 40-2 . . . 40-M. The array 65-2 and characteristics of its ultrasound transducers 40 (e.g., number M, type, excitation frequency, beam width) can be similarly tailored to the second area of the battery cell (e.g., 60-2 as shown in FIG. 2). In some embodiments, the number N of ultrasound transducers 30 included in array 65-1 can be different from the number M of ultrasound transducers 40 included in array 65-2.

FIG. 9B shows an exemplary configuration of a transducer module 34 that can be used in an inspection system (e.g., inspection system 2000 of FIG. 7). Each transducer module 34 can include an array 65-1 including one or more ultrasound transducers 30. FIG. 9C shows an exemplary configuration of a transducer module 36 that can be used in an inspection system (e.g., inspection system 2000 of FIG. 7). Each transducer module 36 can include an array 65-2 including one or more ultrasound transducers 40.

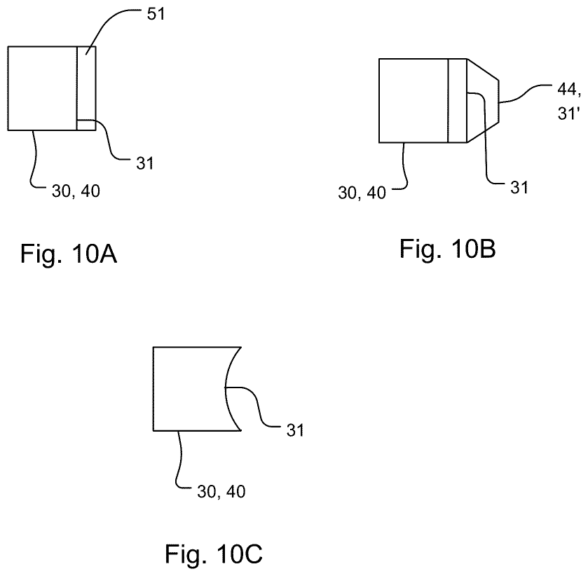

FIG. 10A shows an ultrasound transducer 30, 40 with a couplant 51 attached to the face 31 of the transducer. FIG. 10B shows an ultrasound transducer 30, 40 with a focusing clement 44 attached to the face 31. Because the focusing clement attaches to the face 31, an outside surface of the focusing clement 44 operates as an effective face 31′ of the transducer 30, 40. For example, the focusing element 44 can be an acoustic lens.

In some embodiments, the transducers 30, 40 can be unfocused, focused, or be components of beam-formed arrays 65. In some embodiments, the transducers 30, 40 can be capable of generating a high enough acoustic pressure to penetrate the battery cell 1035 and propagate through it, and/or the beam width can be narrow enough to allow sub-millimeter lateral resolution. Such a lateral resolution can help resolve layer misalignments that are less than 1 mm wide. In some embodiments, these requirements can be satisfied by using focused transducers or beam-formed arrays. For example, a transmitted ultrasound signal of frequency of about 5 MHz with a beam width of approximately 0.5 mm can be used to detect misalignment in a range between about 0.5 mm and about 2 mm of a layer 70, relative to each of its adjacent layers 70.

In some embodiments, for a minimum misalignment size of 0.5 mm, a similar focal width (e.g., the full beamwidth at the focal point) can be used. To achieve such a narrow beam to first order, an F number of the transducer (defined as depth of focus over the aperture size) can be small (e.g., suggesting an aperture size that is about 50-60 wavelengths in diameter). This implies a combination of high frequency and fairly large aperture. For example, to satisfy the requirement at 3 MHz, the aperture size would be 25 mm, while at 5 MHz the aperture size would be 18 mm. In some embodiments, the depth of field can be constrained, for example, to under 10 mm, which may be sufficient to interrogate shallow targets. The design of such a system can be application specific, for example, depending on the size and characteristics of the battery cell, the expected depth of the misalignment defects, and/or other factors.

FIG. 11 shows more detail for the inspection systems 1000, 2000 than could be shown in FIGS. 6 and 7. In the illustrated example, the enclosure 20 is viewed from a top 23 of the enclosure, with a front 78 of the enclosure 20 located at the bottom of FIG. 11. The enclosure 20 also has a left side 77 and a right side 79. In the illustrated example, the enclosure 20 is substantially cuboid/has a substantially rectangular prism shape and is constructed in a chassis form factor. In some embodiments, the enclosure 20 can have multiple rails 29 that connect in a modular and/or adjustable fashion. The rails 29 can provide support for components within the enclosure 20 and can enable attachment of components to the enclosure 20. Spaces/gaps between the rails 29 can allow operators of the inspection system to access the components and/or monitor operation of the system.

In FIG. 11, the pass bin 822 and the fail bin 824 are also shown at the front 78 of the enclosure 20. Based on the misalignment score 71 that the processing system 900 calculates for each battery cell 1035, the controller 800 might instruct the transport module 19 to move each interrogated battery cell 1035 to either the pass bin 822 or the fail bin 824. Additional components of the transport module 19 are visible in FIG. 11. These components include a staging conveyor 16, an incoming gantry 28-1, an outgoing gantry 28-2, a rolling path 15, trays 14, and palettes 12. The rolling path 15 extends from the left side 77 of the enclosure 20 to its right side 79 and is located near the front 78 of the enclosure 20. The trays 14 can rest upon the rolling path 15 and can hold multiple battery cells 1035 in a specific X-Y location and orientation within each tray 14. The trays 14 include an incoming tray 14-1, a staging tray 14-2, a processed cell tray 14-3, and an outgoing tray 14-4. The palettes 12 can hold a smaller amount of battery cells 1035 than do the trays 14 and can be placed upon the staging conveyor 16. For example, the palettes 12 can hold four (4) or six (6) battery cells 1035. The battery cells 1035 can be placed in the palettes 12 just prior to placing the battery cells 1035 on the interrogation conveyor 17. An empty palette 12E is shown in FIG. 11.

The tank 24 is substantially rectangular in shape, is open at its top, and is longest along its tank length 74. The tank is located near the back 81 of the enclosure 20. In the illustrated example of FIG. 11, two pairs of opposing ultrasound transducer modules are also shown, in accordance with the inspection system of FIG. 7, and are arranged to be substantially parallel with inside walls of the tank 24 along the tank length 74. Of the two pairs, a first pair includes transducer modules 34-1 and 34-2, and second pair includes transducer modules 36-1 and 36-2. Transducer modules 34-1 and 36-1 are included within the tank 24, are attached to an inside wall of the tank 24 nearest to the back 81 of the enclosure 20, and are arranged from left to right along the tank length 74.

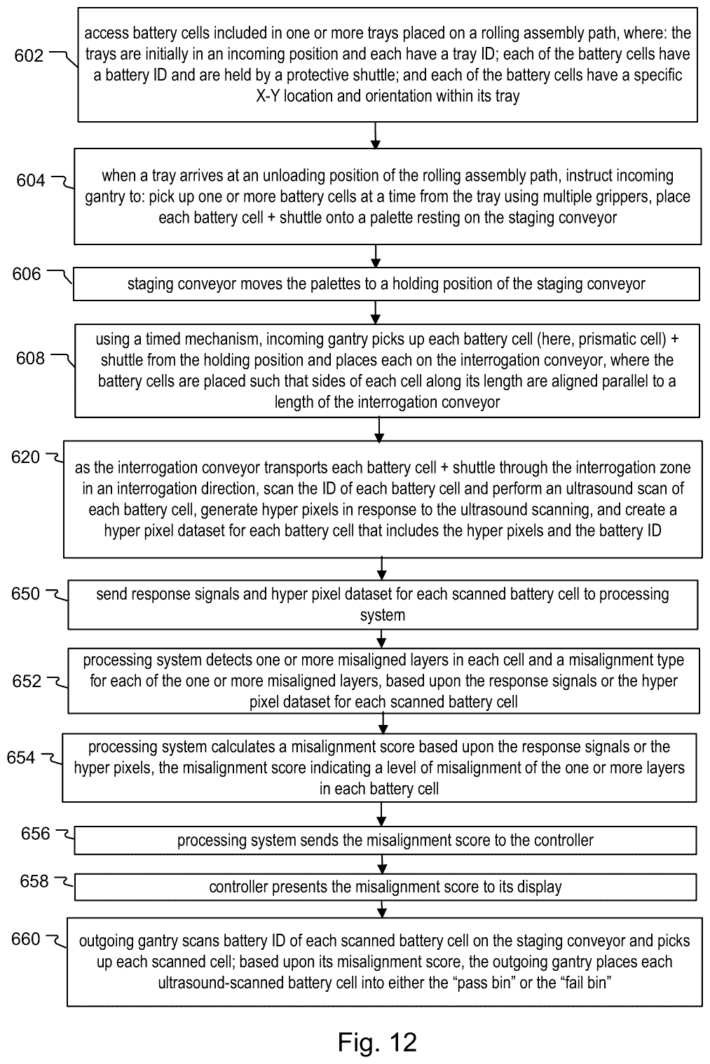

Similarly, transducer modules 34-2, 36-2 are included within the tank 24, are attached to an inside wall of the tank 24 nearest to the front 78 of the enclosure 20, and are arranged from left to right along the tank length 74. The two pairs are included within the interrogation zone 22. It can also be appreciated that the enclosure 20 might instead include the transducer modules 32-1 and 32-2 of the inspection system of FIG. 6. The tank 24 can be filled with an electrically non-conductive fluid (not visible in the figure). The transducer modules 34, 36 and their ultrasound transducers can be immersed in the fluid. Further details regarding operation of the inspection system of FIG. 11 can be found, for example, in the description below regarding the method of FIG. 12.

### Misalignment Detection Method Examples

FIG. 12 is a flowchart of a method of operation of an inspection system for detecting layer misalignment, such as the inspection system 2000 of FIG. 7 and its enclosure 20 shown in FIG. 11. For example, the method can describe how the inspection system performs an ultrasound interrogation of one or more battery cells and calculates a misalignment score for each battery cell in response to the interrogation. The method can begin at step 602, where the inspection system (e.g., system 2000) can access one or more battery cells (e.g., battery cells 1035) included in one or more trays (e.g., trays 14) placed on the rolling assembly path (e.g., path 15). The trays can initially be in an incoming position, and each tray can have a tray ID. Each of the battery cells can have a battery ID and can be held by a U-shaped protective shuttle (e.g., shuttle 26). Each of the battery cells can have a specific X-Y location and orientation within its tray. Each battery cell within the trays can also be seated within an individual U-shaped fixture or shuttle (e.g., shuttle 26). The shuttle can protect each cell, hold each cell, and/or keeps each cell upright within the tray. Alternatively or additionally, the shuttle can also leave the sides of the cells (along their length) exposed/unblocked by the shuttle, for example, in order to allow the long sides of each cell that face the transducer modules (e.g., modules 32, 34) to be unobstructed during ultrasound interrogation.

According to step 604, when a tray arrives at an unloading position of the rolling assembly path, the inspection system (e.g., via its controller 800) can instruct the incoming gantry (e.g., gantry 28-1) to pick up one or more battery cells at a time from the incoming tray (e.g., tray 14-1) using multiple grippers of the incoming gantry and to place each battery cell and shuttle onto a palette (e.g., palette 12) resting on the staging conveyor (e.g., conveyor 16). In step 606, the staging conveyor can then move the palettes to a holding position of the staging conveyor.

In step 608, using a timed mechanism at the controller (e.g., controller 800), the incoming gantry can pick up each battery cell and shuttle from the palettes at the holding position, and can then place each battery cell and its shuttle upon the interrogation conveyor (e.g., conveyor 17).

The battery cells can be placed such that sides of the cells (e.g., sides 45, 55) along their length L are aligned parallel to a length of the interrogation conveyor/parallel with the tank length (e.g., length 74). As a result, the long sides of the cells face the ultrasound transducers of the transducer modules (e.g., modules 34-1, 34-2, 36-1, and 36-2). The length of the interrogation conveyor can also be substantially parallel to the tank length.

In step 620, as the interrogation conveyor transports each battery cell and shuttle into the interrogation zone (e.g., zone 22) in the interrogation direction (e.g., direction 21), the inspection system scans the ID of each battery cell and performs an ultrasound scan/interrogation session of each battery cell, generates hyper pixels (e.g., hyper pixels 100) for the response signals in response to the ultrasound scanning, and creates a hyper pixel dataset for each battery cell that includes the hyper pixels and the battery ID. In step 650, the controller can send the response signals and the hyper pixel dataset for each ultrasound-scanned battery cell to the processing system (e.g., processing system 900).

According to step 652, the processing system detects one or more misaligned layers (e.g., layers 70) in each cell and a misalignment type for each of the one or more misaligned layers, based upon the response signals or the hyper pixel dataset for each scanned battery cell. With reference to FIGS. 3A-3D and 4A-4D, the processing system can detect short layer misalignment 170S of anode layers 70A or cathode layers 70C, and a misalignment type of short anode misalignment or short cathode misalignment. Alternatively or additionally, the processing system can detect long layer misalignment 170L of anode layers 70A or cathode layers 70C, and a misalignment type of long anode misalignment or long cathode misalignment. Alternatively or additionally, the processing system can detect folded layer misalignment 170F of anode layers 70A or cathode layers 70C, and a misalignment type of folded anode misalignment or folded cathode misalignment. It can also be appreciated that the inspection system can detect folded electrode assemblies, using similar techniques for detecting folded layers. Thus, the system can also detect folded electrode assemblies and a misalignment type of folded electrode assembly misalignment.

In step 654, the processing system can calculate a misalignment score (e.g., score 71) for each battery cell, based upon the response signals or the hyper pixel dataset for each scanned battery cell. According to step 656, the processing system can send the misalignment score to the controller. The processing system can also store the misalignment score and the detected misalignment type(s) for each detected misaligned layer for each battery cell, along with its battery ID, to a record for each battery cell at the data repository (e.g., repository 200). In step 658, the controller can present the misalignment score to its display (e.g., display 820). Then, in step 660, the outgoing gantry (e.g., gantry 28-2) scans the battery ID of each ultrasound-scanned battery cell and picks up each cell. Based upon its ID and misalignment score, the outgoing gantry can place each ultrasound-scanned battery cell in either the pass bin (e.g., bin 822) or the fail bin (e.g., bin 824).

Additionally or alternatively, the controller can instruct the outgoing gantry to place each battery cell in the outgoing tray (e.g., tray 14-4). Because the misalignment score and associated battery ID for each battery cell is stored at the data repository (e.g., repository 200), the controller might then instruct the outgoing gantry to scan the battery ID of each scanned battery cell in the outgoing tray, and perform a lookup of its misalignment score at the data repository. The controller can then present icons for each battery cell in the outgoing tray on the display, along with the battery ID for each. Alternatively or additionally, the controller can present a different color for each battery icon based on its misalignment score (e.g., green for a non-misalignment score, red for a misalignment score indicating misalignment).

In some embodiments, the controller might perform additional actions regarding the battery cells based on the misalignment score. For example, the controller can present a first color (e.g., green) to the display when the misalignment score indicates non-misalignment, and present a different color (e.g., red) when the misalignment score indicates misalignment. In another example, the controller might include the misalignment score in a message, and send the message (e.g., via email or text message) to a user device (e.g., mobile phone, laptop, tablet, phablet, computer workstation) of an operator of the inspection system. It is also possible for the processing system, or any other component of the inspection system, to perform the actions regarding the battery cells based on the misalignment score, in addition to or instead of the controller, according to one or more contemplated embodiments of the disclosed subject matter.

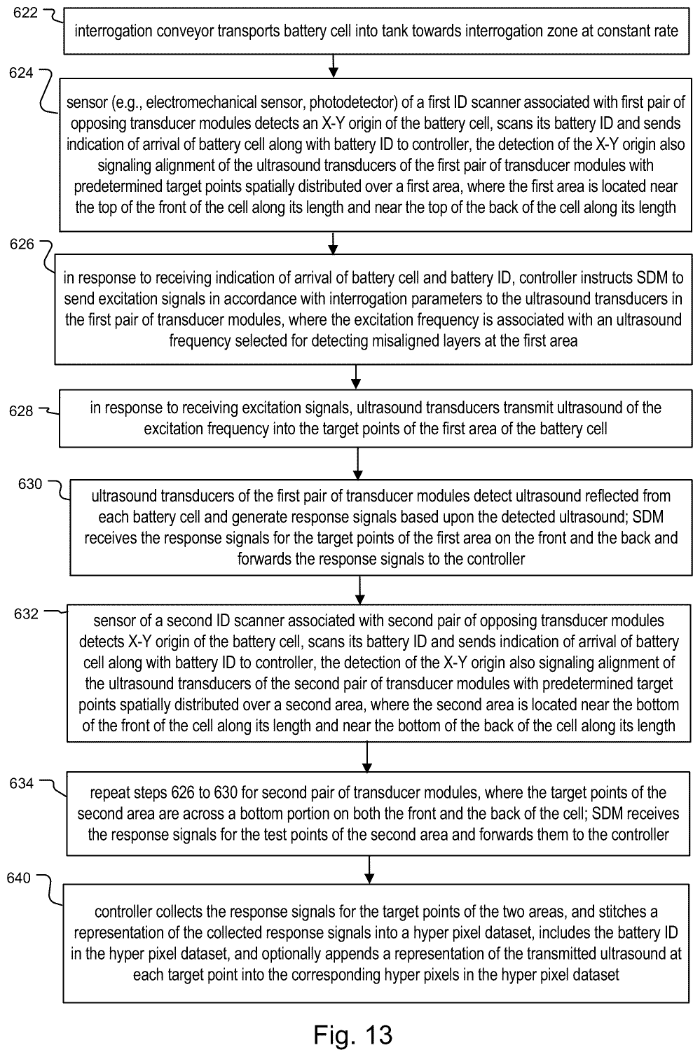

FIG. 13 is a flowchart that provides more detail for step 620 in the flowchart of FIG. 12, and lists method steps for operation of an inspection system (e.g., inspection system 2000) in performing an ultrasound interrogation session of each battery cell in an interrogation zone (e.g., zone 22). The method begins at step 622, where an interrogation conveyor (e.g., conveyor 17) transports a next battery cell (e.g., cell 1035) into the tank (e.g., tank 24) toward the interrogation zone, for example, at a constant rate. At step 624, a sensor (e.g., an electromechanical sensor or photodetector) of a first ID scanner associated with the first pair of opposing transducer modules (e.g., modules 34-1, 34-2) can detect an X-Y origin of the battery cell, can scan its battery ID, and can send an indication of arrival of the battery cell along with the battery ID to the controller (e.g., controller 800). The detection of the X-Y origin can also signal alignment of the ultrasound transducers of the first pair of transducer modules 34-1, 34-2 with predetermined target points (e.g., points 110) spatially distributed over a first area (e.g., area 60-1) of the battery cell. For example, the first area of the battery cell can be associated with a top portion of both the front (e.g., front 45) and the back (e.g., back 55) of the battery cell, which respectively face the transducer modules (e.g., modules 34-1, 34-2).

According to step 626, in response to receiving the indication of arrival of the battery cell and its battery ID, the controller can instruct the SDM (e.g., SDM 1090) to send excitation signals in accordance with the interrogation parameters (e.g., parameters 80) to the ultrasound transducers (e.g., transducers 30) in the first pair of transducer modules. For example, the SDM can send an excitation signal to each of the transducers in the transducer modules, where the excitation frequency is associated with an ultrasound frequency selected for detecting misaligned layers at the first area. For example, the ultrasound transducers of the first pair of transducer modules can be configured for pulse-echo mode operation.

In step 628, in response to receiving the excitation signals, the ultrasound transducers of the transducer modules can transmit ultrasound for the selected excitation frequency into the target points of the first area of the battery cell 1035. As noted above, the first area can be across a top portion of both sides (e.g., front 45 and back 55 sides) of the cell along its length L. In step 630, the ultrasound transducers in the first pair of transducer modules can detect ultrasound reflected from the battery cell and can generate response signals for the target points of the first area, from both the front and back, based upon the detected ultrasound. The response signals can be received by the SDM, which can forward the response signals to the controller.

At step 632, a sensor of a second ID scanner associated with the second pair of opposing transducer modules (e.g., modules 36-1, 36-2) can detect an X-Y origin of the battery cell, can scan its battery ID, and can send an indication of arrival of the battery cell along with the battery ID to the controller (e.g., controller 800). The detection of the X-Y origin can also signal alignment of the ultrasound transducers (e.g., transducers 40) of the second pair of transducer modules with predetermined target points (e.g., points 110) spatially distributed over a second area (e.g., area 60-2) of the battery cell. For example, the second area of the battery cell can be associated with a bottom portion of both the front (e.g., front 45) and the back (e.g., back 55) of the battery cell, which respectively face the transducer modules (e.g., modules 36-1, 36-2). For example, the transducers (e.g., transducers 40) of the transducer modules (e.g., modules 36-1, 36-2) can also be configured for pulse-echo mode operation.

According to step 634, the inspection system can repeat steps 626 to 630 for the second pair of transducer modules, where the target points are across the second area on both sides (e.g., sides 45, 55) of each cell along its length L. The SDM can receive the response signals for the target points of the second area and can forward them to the controller. Then, in step 640, the controller can collect the response signals for the target points (e.g., points 110) for the two areas (e.g., areas 60-1, 60-2) and can stitch a representation of the collected response signals into a hyper pixel dataset. The collection of response signals at each target point is also known as a hyper pixel (e.g., hyper pixel 100) for each target point (e.g., point 110). In some embodiments, the controller can also append a representation of the transmitted ultrasound at each target point into the corresponding hyper pixels in the hyper pixel dataset.

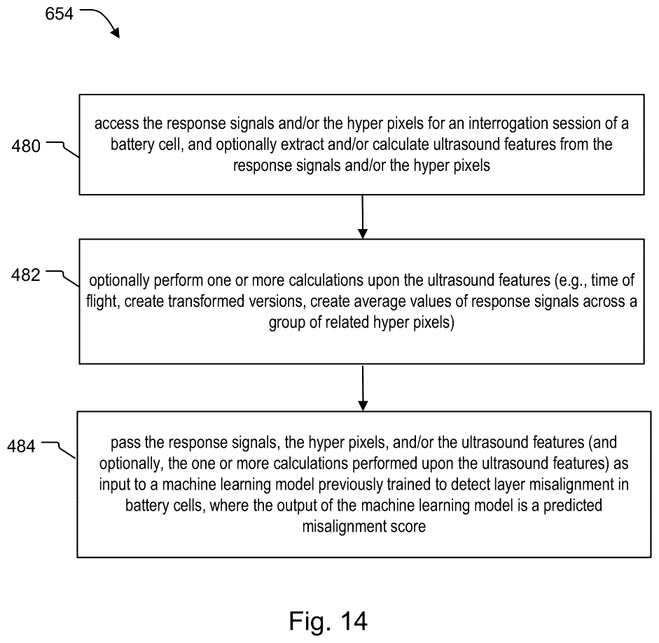

FIG. 14 is a flowchart that provides more detail for step 654 in the flowchart of FIG. 12, and describes how the processing system (e.g., processing system 900) can determine layer misalignment of battery cells via machine learning. The method begins at step 480, where the processing system can access the response signals and/or the hyper pixels for an interrogation session of a battery cell. The processing system can extract and/or calculate ultrasound features from the response signals of the hyper pixels. According to step 482, the processing system can perform one or more calculations upon the ultrasound features (e.g., time of flight, create transformed versions in the frequency domain via Fourier or Hilbert transforms, create average values of response signals across a group of related hyper pixels, and identify zero crossings).

In step 484, the processing system can pass the response signals, the hyper pixels, and/or the ultrasound features (and optionally, the one or more calculations performed upon the features) as input to a machine learning model (e.g., model 75) previously trained to detect layer misalignment in battery cells. For example, the machine learning model can be trained using information associated with misaligned layers detected in multiple reference battery cells. The reference battery cells can be destructively torn down to verify the misalignment detected via ultrasound. Alternatively or additionally, prior to any destructive teardown, the reference battery cells can be subjected to computed tomography (CT) scans, for example, to verify the layer misalignment via ultrasound. For example, an output of the machine learning model can be, or at least include, the predicted misalignment score that indicates a level of layer misalignment within the battery cell.

Additionally or alternatively, the processing system might pass ultrasound features extracted from the response signals/hyper pixels, and/or one or more of the ultrasound features, as input to the machine learning model. The extracted ultrasound features can be experimentally determined to detect misaligned layers in battery cells. For example, a first ultrasound feature can be a variation of null ultrasound feature in the frequency spectrum. Alternatively or additionally, a second ultrasound feature can be to use phase information of the response signal in the frequency domain, and to see whether the signal changes (typically, whether the phase shifts in frequency over time) due to misalignment. Alternatively or additionally, a third feature can be obtained by comparing the variation of the response signal in the time domain in the resonance part (e.g., after the first echo coming from the boundary between a delay line 1720 and the cell 1035).

Although some of steps 602-608, 620, 650-660 of FIG. 12, steps 622-640 of FIG. 13, and steps 480-484 of FIG. 14 have been described as being performed once, in some embodiments, multiple repetitions of a particular step (or portion thereof) may be employed before proceeding to the next step. In addition, although steps 602-608, 620, 650-660 of FIG. 12, steps 622-640 of FIG. 13, and steps 480-484 of FIG. 14 have been separately illustrated and described, in some embodiments, steps (or portions thereof) may be combined and performed together (simultaneously or sequentially). Moreover, a particular order is illustrated for steps 602-608, 620, 650-660 of FIG. 12, steps 622-640 of FIG. 13, and steps 480-484 of FIG. 14, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIGS. 12-14. Alternatively or additionally, in some embodiments, the method may comprise only some of steps 602-608, 620-640, and 480-484 (or portions thereof).

### Additional Misalignment Detection Examples

By way of background, transmission and reflection are not the only physical processes that develop when an acoustic wave impinges upon a structure. For example, an acoustic wave transmitted into an elastic sphere will result in a scattered echo that combines a specular reflection, internal compressional waves, flexural surface waves, and circumferential waves. Similarly, an acoustic wave that is transmitted into a flat plate will result in an echo that combines a reflection at the interface, scattering from irregularities, resonance effects, and mode conversions. The way each structure responds to an acoustic wave depends on the shape of the structure, its characteristic dimension, and its material properties (e.g., speed of sound, density, etc.), and/or the excitation loading the structure. For example, a high frequency wideband excitation of a 3.2 mm diameter aluminum sphere will give rise to the aforementioned wave types, which will add up constructively or destructively depending on frequency and geometry. In addition, if one of the excitation frequencies matches one of the sphere's natural frequencies, it will result in a resonance vibration that could strongly affect the scattered wave. The distinct scattering behavior can also persist if the target is placed in a different environment, such as an aluminum enclosure. Though the received signal is strongly affected by the presence of the aluminum wall, the characteristics of the sphere's frequency response are still observable.

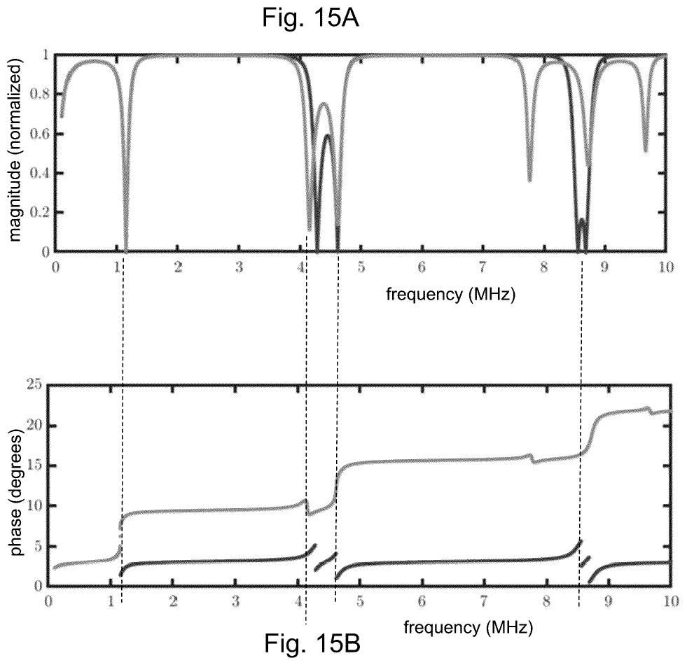

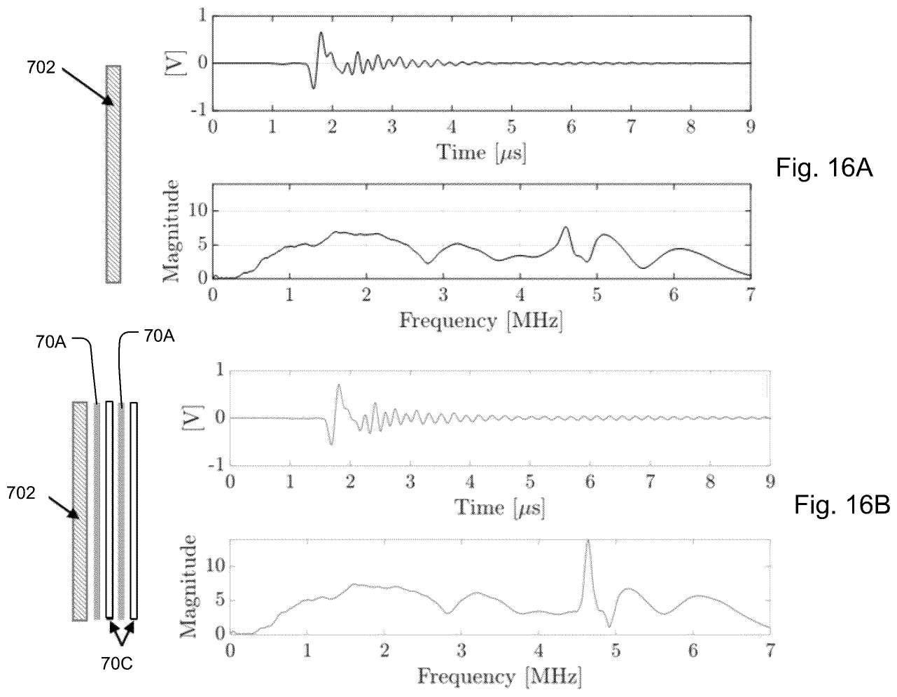

In a simple example, FIGS. 15A-15B show a modelled reflection response of 10-μm thick copper layer placed within 0.75-mm-thick aluminum walls in a water bath. The copper layer represents an anode layer in a battery cell 1035, while the aluminum wall represents a typical aluminum housing in a prismatic cell 1035. FIG. 15A is a magnitude versus frequency plot, while FIG. 15B is a magnitude versus phase plot. The water bath uses electrically non-conductive water, such as deionized water. The periodicity and the reflectivity minima (and corresponding transmittance maxima) depend on the material thickness and parameters. It is expected that such oscillations and resonances in the frequency domain will change somewhat depending on the influence of the structure surrounding the structure of interest. For example, the resonant behavior might shift up or down in frequency, while the amplitude and/or phase might shift and therefore change the frequency response. These effects can be exploited to determine the presence of misaligned layers in a battery cell 1035.

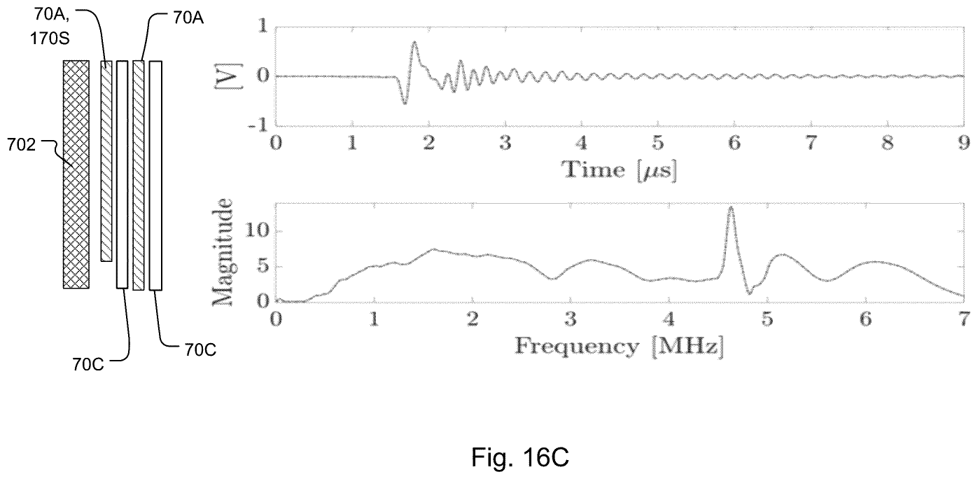

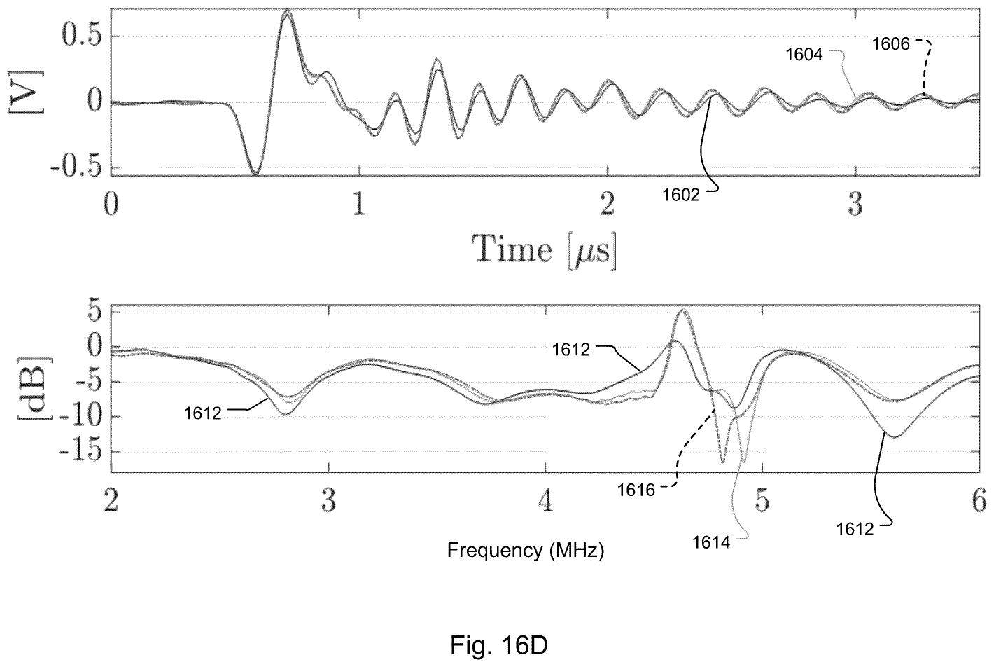

FIGS. 16A-16C show the effect of ultrasound transmitted into a battery cell (e.g., cell 1035) via an immersion inspection system (e.g., system 1000 or 2000), for a prismatic battery cell with housing only (FIG. 16A), for a cell with housing and including no misaligned layers (FIG. 16B), and for a cell with housing and a misaligned layer (FIG. 16C). FIG. 16D shows plots of signals combined from FIG. 16A through FIG. 16C. In more detail, FIG. 16A shows the effect of ultrasound transmitted into an aluminum housing 702 of a battery cell, without layers 70 within the housing 702. After ultrasound is transmitted into the housing 702, the reflected ultrasound is detected and plotted in the time domain at the top right of the figure. A transformed version of the time domain signal in the frequency domain is shown at the bottom right.

FIG. 16B repeats the ultrasound transmission shown in FIG. 16A, where the housing 702 additionally includes alternating, non-misaligned anode layers 70A and cathode layers 70C. The time domain plot at the top right of the figure shows the contribution of both the aluminum housing 702 and the layers 70 upon the reflected time domain signal, and the frequency response plot of the time domain signal is shown at the bottom right. In the frequency domain plot, there is a base ‘carrier’ component that is the contribution from the housing 702 that is modulated by the presence and configuration of the layers 70.

FIG. 16C repeats the ultrasound transmission shown in FIG. 16B. However, one of the layers (here, an anode layer 70A) has a misaligned short layer 170S. The time domain plot at the top right of the figure shows the contribution of both the aluminum housing 702 and the layers 70 upon the reflected time domain signal, and the frequency response of the time domain signal is shown at the bottom right. While the response signals in FIGS. 16B-16C are similar in appearance, the layer misalignment in FIG. 16C introduces a measurable frequency shift. This is described more in association with FIG. 16D, herein below.

FIG. 16D shows, at the top, a composite time domain signal of the time domain signals of FIGS. 16A through 16C. At the bottom, a plot of the frequency response of the composite time domain signal is shown. Information extracted from these plots (e.g., ultrasound features) can be used to detect layer misalignment. With reference to the time domain composite plot of FIG. 16D, reference 1602 is the response signal from the housing 702 only, in FIG. 16A; reference 1604 is the response signal from the housing 702 and non-misaligned layers, in FIG. 16B; and reference 1604 is the response signal of the housing 702 and layers with one misaligned layer, in FIG. 16C. While the waveforms of the signals 1604 and 1604 are nearly identical, there are still differences in amplitude between each, and between each and the baseline signal 1602. In some embodiments, the processing system (e.g., system 900) can use these differences as one of the ultrasound features for detecting misaligned layers.

The frequency domain plot of the composite time signal at the bottom of FIG. 16D provides even more information for detecting misaligned layers. References 1612, 1614, and 1616 are the frequency domain versions of the time domain signals 1602, 1604 and 1606, respectively. In more detail, the waveforms of 1612 and 1616 are very similar, and between 2 MhZ and 4 MHz, there are no appreciable differences in the three signals 1612, 1614, and 1616. However, starting at around 4.3 MHz, the signals 1614 and 1616 begin to diverge from the baseline signal 1612. In particular, at approximately 4.5 MHz, there is a common increase in the amplitude of the signals 1614, 1616 as compared to the baseline signal 1612. In addition, there is a null value for signal 1614 at approximately 4.9 MHz, with a same null value for signal 1616 at approximately 4.8 MHz. Thus, there is a significant frequency shift of 100 kilohertz (kHz) of signal 1616 to the left at its null value, as compared to the null value of signal 1614. In some embodiments, a processing system (e.g., system 900) can use this frequency shift, alone or in combination with the differences in the amplitudes and waveforms of the signals 1612, 1614, and 1616 at different frequencies, to detect misaligned layers.

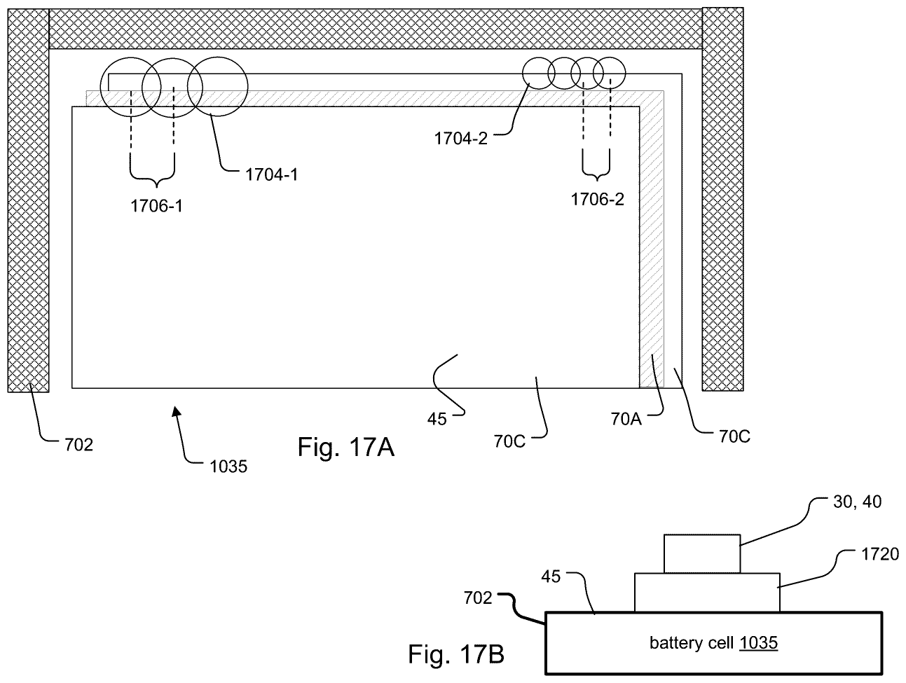

FIG. 17A illustrates the effect of selection of ultrasound beam width 1704 and scan step size 1706 parameters for interrogation of a prismatic battery cell, for example, to optimize, or at least improve, the detection of misaligned layers within the cell. The scan step size 1706 is the distance between adjacent target points (e.g., target points 110) in each area (e.g., area 60), along the length L of the sides 45, 55 of the battery cell 1035. In the illustrated example, two different beam widths 1704-1 (wide) and 1704-2 (narrow) are shown. A wide acoustic beam width 1704-1, such as a width that is 1.5 times greater or more than the width or gap (e.g., gap 43) of the layer misalignment, can reduce the ability to detect small defects. A narrower acoustic beam width 1704-2, such as a width that is selected to be in a range that is greater than 0.5 times the width or gap (e.g., gap 43) but less than or equal to the width or gap (e.g., gap 43), can improve the ability to detect small defects. At the same time, a smaller acoustic beam width can require more ultrasound acquisitions and/or a smaller scan step size 1706. In some embodiments, the beam width 1704 at the location of the misalignment and the scan step size 1706 can be selected to detect submilimeter misalignments.

In some embodiments, if a beam width 1704 is selected that is typically equal to or slightly larger than the width between adjacent layers, then there is a strong likelihood of finding misaligned layers while minimizing scan time. Alternatively, if a beam width 1704 is selected that is smaller than the width between adjacent layers, then the likelihood of detecting misaligned layers can be further improved; however, doing so requires an increase in the number and/or density of target points, which increases scan time and processing time. Alternatively, if a beam width 1704 is selected to be too large (e.g., greater than 3× the width between adjacent layers 70), the ability to detect misaligned layers significantly decreases, for example, due to most of reflected signals received over this larger area (defined by the beam width 1704) being outside of the width between the layers and thus contributing to noise. In some embodiments, such as for the contact transducers in the inspection system 3000, the scan step size 1706 for moving the transducer in the scan direction 93 can allow for overlap (e.g., at least a 50% overlap) between two adjacent or successive acquisitions, for example.

FIG. 17B shows a delay line 1720 (e.g., made of acrylic) placed between a face (e.g., face 31) of a contact transducer 30 and a surface/side 45 of the battery cell 1035. The delay line 1720 can be employed so that the near-field of the ultrasound signal is not located inside the battery cell. Rather, with prismatic cells, in one example, the delay line 1720 can “shift” the transmitted ultrasound signal such that its near-field is located outside of the housing 702, which may allow the signal to penetrate further into the cell 1035 along its depth D. When interrogating the battery cell 1035 with the added delay line 1720, the first received echo of the response signal comes from the boundary between the delay line 1720 and the cell that contains the frequency response of the pulse. However, the subsequent echoes are mostly due to the housing 702 (e.g., aluminum) resonating at its resonance frequency. The frequency spectrum of the entire response signal will thus have a dip in the signal, associated with the resonance frequency of the housing 702. This is due to destructive interference between the resonance frequency and the ultrasound pulse.

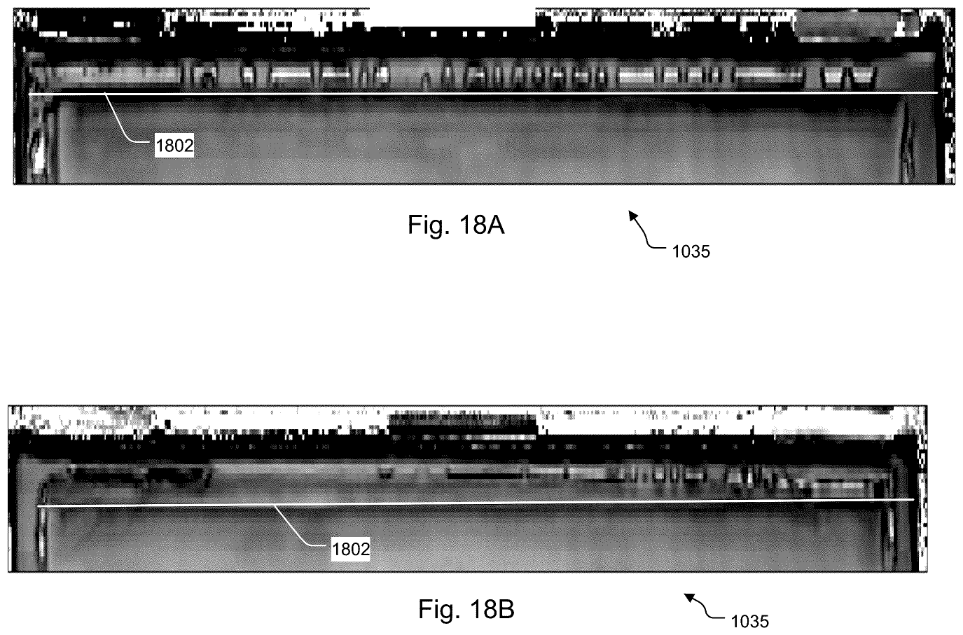

FIGS. 18A and 18B shows ultrasound scan images of a cell having no misaligned layers in FIG. 18A, and of a cell 1035 with misaligned layers in FIG. 18B. The images show one ultrasound feature 1802 extracted from the response signals/hyper pixels (e.g., hyper pixels 100) that the processing system (e.g., processing system 900) used to identify misaligned layers. In the illustrated example, the ultrasound feature 1802 is the variation of null in the frequency spectrum when moving from a location with misalignment to a normal location. Using the ultrasound feature 1802, the image of the battery cell 1035 in FIG. 18A shows straight layers 70 relative to the ultrasound feature 1802. As such, no misalignment is detected in the cell of FIG. 18A. In contrast, FIG. 18B shows layers 70 at an angle relative to the ultrasound feature 1802. Layer misalignment was thus detected in the cell of FIG. 18B.

In some embodiments, three different features (taken alone or in combination) can be used for the detection of misalignment. For example, a first ultrasound feature can be the variation of null ultrasound feature 1802 described above. A second ultrasound feature can be to use phase information of the response signal in the frequency domain, and to see whether the signal changes (typically, whether the phase shifts in frequency over time) due to misalignment. A third feature can be to compare the variation of the response signal in the time domain in the resonance part (e.g., after the first echo coming from the boundary between a delay line 1720 and the cell).

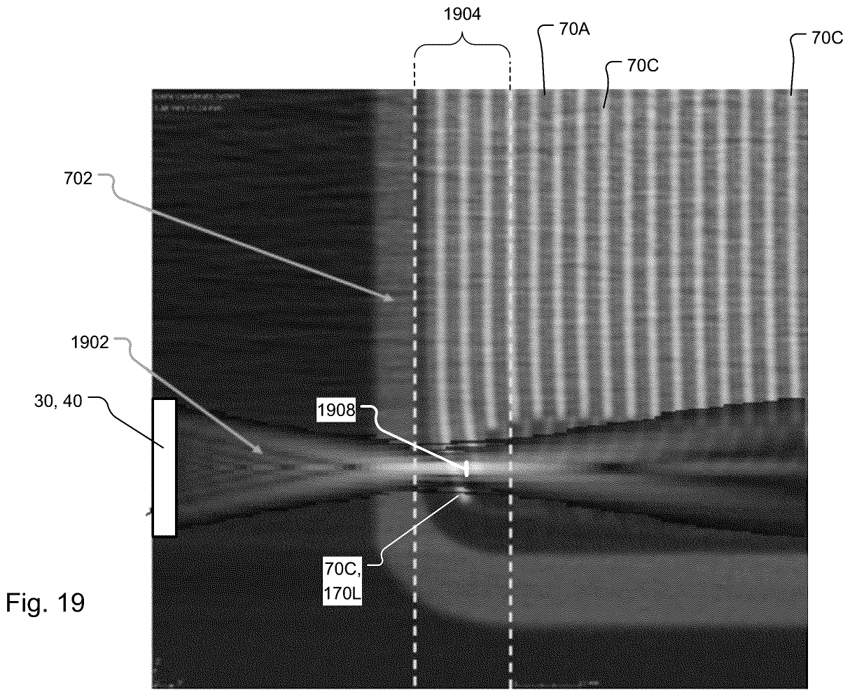

FIG. 19 is a partial CT scan image of a front of a prismatic battery cell, taken during an ultrasound interrogation of the cell by an inspection system (e.g., similar to inspection systems 1000, 2000, 3000). The image shows a focused ultrasound beam 1902 transmitted into the cell by an ultrasound transducer 30, 40, and shows a focal zone 1904 within the cell for optimal detection of misaligned layers within the cell 1035. In the illustrated example, a long layer misalignment 170L of a cathode layer 70C is shown within the battery cell 1035. A region of interest is selected within the focal zone 1904 to include the misaligned long layer 170L. The frequency of the ultrasound beam is then selected to obtain a desired axial resolution of the transmitted ultrasound to be within the focal zone 1904. Axial resolution can be a property of the transducer response and, among other parameters, it can depend on its frequency characteristics. High axial resolution provides the ability to identify more detail between adjacent layers 70. High frequency imaging (in this case, the transmitted ultrasound signal has a frequency of 5 MHz) has good axial resolution but has limited penetration because high frequencies attenuate faster than slower frequencies.

FIG. 19 also shows the effect of lateral resolution 1908, which is a measure of the width of the ultrasound beam 1902 at a selected region of interest within the focal zone 1904. In some embodiments, the ultrasound beam 1902 (or effective beam diameter) can fall fully inside the cell and can avoid covering the cell's edge, for example, to prevent edge effects. Additionally, the data can be collected close to the edge because misalignment typically occurs at the edge of the cell. Since the hard housing 702 of the cell 1035 has a resonance frequency, this resonance frequency can be found (e.g., measured). The ultrasound transducer and/or operation thereof can then be selected in a way to have a center frequency equal to the resonance frequency of the housing 702. This resonance frequency may depend on the thickness of the housing 702. The excitation can be done by using a pulser-receiver that gives a small axial resolution, for example, by using a spike for excitation. On the receiver side, the received signal can be amplified to have a good signal-to-noise ratio (SNR) in the resonance part of the signal. The first received echo can come from the boundary between the delay line 1720 and the cell that contains the frequency response of the pulse. However, the subsequent echoes are mostly due to the case resonating at its resonance frequency.

In some embodiments, a linear array and beam-forming can be used to focus the beam 1902, for example, by electronically adjusting the time delays applied to the elements of the array. Using an ultrasound array, the transducer elements can be combined in sub-arrays by electronically switching them on and off in groups, for example, to generate acoustic beams with variable performance characteristics that can be tailored to the interrogation of each battery cell. In some embodiments, the array can be long enough to completely cover the battery at the region of interest in the focal zone 1904. In some embodiments, an acoustic lens 44 can be attached to the face of the array, for example, to perform the function of a delay line 1720 and/or provide mechanical focusing and/or to improve the depth of the field in the region of interest 1904.

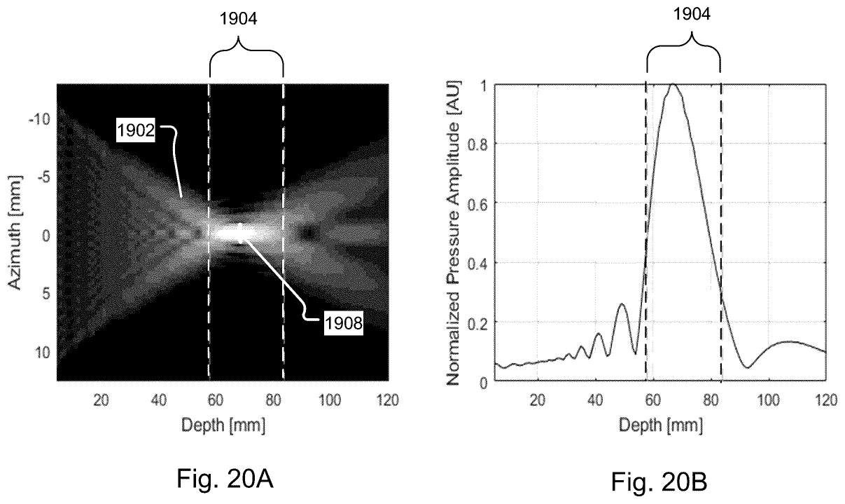

FIG. 20A is calculated plot of a radiated pressure field within a prismatic battery cell (e.g., cell 1035) for an ultrasound beam of 5 MHz transmitted into the cell. The plot is a beam profile of the ultrasound beam 1902 in FIG. 19. The beam 1902 is generated in response to a simple harmonic motion with a frequency of 5 MHz. The horizontal depth axis of the plot refers to the depth inside the battery cell. The vertical azimuth axis of the plot is related to a dimension affected by the lateral resolution 1908 (facing the battery cell). The white oval shows the highest intensity of the beam 1902.

FIG. 20B is a corresponding plot of an on-axis profile of the beam 1902 in FIG. 20A. The transducer focal zone 1904 that is optimal for lateral and contrast resolution is shown. The transducer focal zone 1904 defines a range of locations for the region of interest that provides the best resolution for imaging. The figure also shows that the acoustic intensity (and pressure) of the ultrasound beam 1902 are low until the beam enters the focal zone 1904, where the beam is shown as a white oval at about a depth of 56 mm, and where the acoustic pressure increases substantially for a short distance and drops again at low levels.

In some embodiments, the battery can be immersed in a fluid (e.g., water), and a pair of transducers can be used for interrogation. These transducers can be mounted on a holder, which is in turn attached to a robotic arm. The robotic arm can precisely move the transducers along the cell, for example, to capture data autonomously (or at least semi-autonomously), thus eliminating the need for human involvement during the scanning process and enhancing the reliability of the method.

In some embodiments, the transducers employed can be focused, for example, featuring a small beam diameter and a relatively narrow focal length. This design can enable the detection of small defects near the edge of the case or slightly further from it. In examples, the focal point of the transducers can be adjusted to be on the surface of the cell or slightly inside it, depending on which position provides more insightful information about the internal structure of the cell. In some embodiments, the horizontal and vertical pitch size/scan step size 1706, which is the distance between each capture along the length L of the cell (e.g., cell 1035), can be varied based on the size of the beam at the point of interrogation. This adjustment allows for enhanced resolution (where a smaller pitch size will yield more detailed images but result in longer scan times) or quicker data acquisition (at the expense of lower resolution).

Depending on the location of the misalignment, a flat gain (for defects near the case) or time-gain-compensation (TGC) (for defects deeper inside the cell) can be applied to enhance the SNR. Such amplifications, while potentially distorting the front surface reflection, will not impact the detection of defects as they manifest in the subsequent signals.

In some embodiments, truth data can be used to verify misalignments detected using ultrasound. For example, a CT scan can be used to visualize the internal structure of objects, including lithium-ion (Li-ion) cells. However, the ability to detect a misaligned electrode in a Li-ion cell using a CT scan may depend on several factors, including the resolution of the CT scan, the size of the misalignment, and the materials used in the Li-ion cell. In general, CT scans work by taking multiple X-ray images from different angles around the object and then using computer algorithms to reconstruct a detailed 3D image of the internal structures. If there is a significant misalignment of electrodes in a Li-ion cell, it may be visible in the CT scan as a distortion or irregularity in the structure. CT scans are often used for quality control and inspection in various industries, including electronics and batteries. If there are concerns about the internal structure of a Li-ion cell, a CT scan can provide valuable insights into its integrity and alignment. However, the specific details of how a misaligned electrode would appear in a CT scan would depend on the exact nature of the misalignment and the characteristics of the materials involved. While CT scans can be valuable tools for inspecting the internal structures of objects, including lithium-ion cells, there are some downsides and limitations associated with using CT for this application. For example, the speed at which the CT scan is performed is much slower as compared to the speed at which Li-ion cells are manufactured.

Alternatively or additionally, teardowns can be used. Cell teardowns are a destructive process involving the disassembly and removal of the internal components of the cell including the electrodes and separators. Misalignments larger than a 2-mm may be visible after a teardown. However, due to the destructive nature of a teardown it is difficult to determine whether the misalignment was there before the teardown.

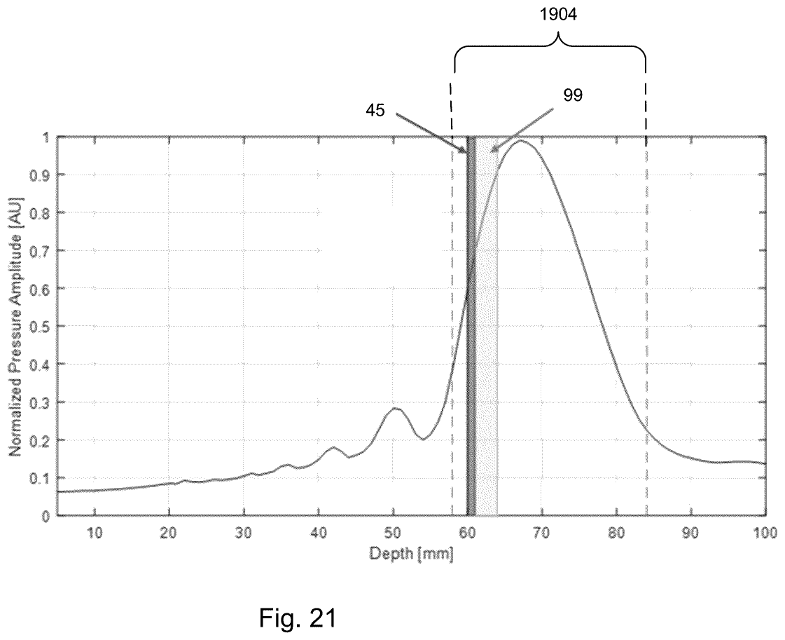

FIG. 21 shows another plot of the on-axis profile of the beam 1902 as in FIG. 20B. For example, information regarding placement of the battery cell relative to/within the focused beam 1902 can be used to optimize detection of misaligned layers within the cell (e.g., cell 1035). In the illustrated example, an ultrasound beam is transmitted at a side (e.g., a front side 45) of a prismatic cell. A region of interest 99 for detecting misaligned layers is shown, where the region of interest 99 is selected to be within the focal zone 1904. This plot also indicates that the ultrasound transducer (e.g., transducers 30, 40) that transmits the ultrasound beam into the battery cell should be placed at a distance away from the front side 45 that is in a range of the depth values of the field of interest 99 (e.g., between 60 mm and 64 mm, inclusive). These values can provide the highest resolution and amplitude of the transmitted ultrasound signal for detecting misaligned layers within the region of interest 99.

### Computer Implementation

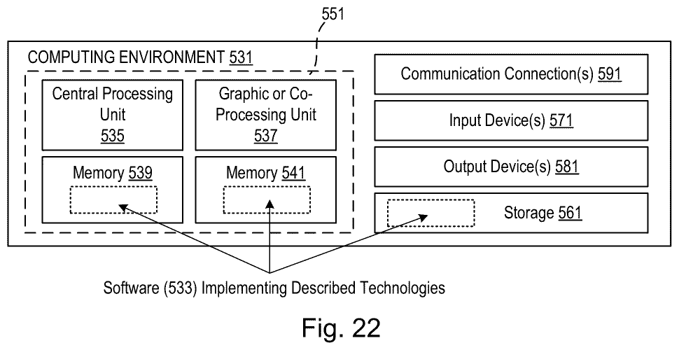

FIG. 22 depicts a generalized example of a suitable computing environment 531 in which the described innovations may be implemented, such as but not limited to aspects of controller 800, processing system 900, SDM 1090, data repository 200, customer facility 240, service provider 260, and/or the method(s) of FIGS. 12-14. The computing environment 531 is not intended to suggest any limitation as to scope of use or functionality, as the innovations may be implemented in diverse general-purpose or special-purpose computing systems. For example, the computing environment 531 can be any of a variety of computing devices (e.g., desktop computer, laptop computer, server computer, tablet computer, etc.).

With reference to FIG. 22, the computing environment 531 includes one or more processing units 535, 537 and memory 539, 541. This basic configuration 551 is included within a dashed line. The processing units 535, 537 execute computer-executable instructions. A processing unit can be a central processing unit (CPU), a processor in an application-specific integrated circuit (ASIC), a microcontroller, or any other type of processor (e.g., hardware processors, graphics processing units (GPUs), virtual processors, etc.). In a multi-processing system, multiple processing units execute computer-executable instructions to increase processing power. For example, FIG. 22 shows a central processing unit 535 as well as a graphics processing unit or co-processing unit 537. The tangible memory 539, 541 may be volatile memory (e.g., registers, cache, RAM), non-volatile memory (e.g., ROM, EEPROM, flash memory, etc.), or some combination of the two, accessible by the processing unit(s). The memory 539, 541 stores software 533 implementing one or more innovations described herein, in the form of computer-executable instructions suitable for execution by the processing unit(s).

A computing system may have additional features. For example, the computing environment 531 includes storage 561, one or more input devices 571, one or more output devices 581, and one or more communication connections 591. An interconnection mechanism (not shown) such as a bus, controller, or network interconnects the components of the computing environment 531. Typically, operating system software (not shown) provides an operating environment for software executing in the computing environment 531 such as the software 533, and coordinates activities of the components of the computing environment 531.

The tangible storage 561 may be removable or non-removable, and includes magnetic disks, magnetic tapes or cassettes, CD-ROMs, DVDs, or any other medium which can be used to store information in a non-transitory way, and which can be accessed within the computing environment 531. The storage 561 can store instructions for the software 533 implementing one or more innovations described herein.

The input device(s) 571 may be a touch input device such as a keyboard, mouse, pen, or trackball, a voice input device, a scanning device, or another device that provides input to the computing environment 531. The output device(s) 581 may be a display, printer, speaker, CD-writer, or another device that provides output from computing environment 531.

The communication connection(s) 591 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed modes or methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. An inspection system comprising:
ultrasound transducers configured to: (i) receive ultrasound excitation signals; (ii) transmit ultrasound at target points of each battery cell, in response to receiving the excitation signals; (iii) detect ultrasound reflected from each battery cell in response to the transmission of the ultrasound at the target points; and (iv) to generate response signals based upon the detected ultrasound at the target points;
a transport module that is configured to move each battery cell relative to the ultrasound transducers and/or to move the ultrasound transducers relative to each battery cell, during the ultrasound interrogation of each battery cell;
a controller and a signal drive and acquisition system (SDM), wherein the SDM is configured to generate and send the excitation signals to the ultrasound transducers, to receive the response signals associated with the detected ultrasound at the target points from the ultrasound transducers, and to forward the response signals to the controller; and wherein the controller creates a hyper pixel for the response signals at each of the target points, each hyper pixel including a representation of the response signals generated for each of the target points; and
a processing system configured to: (i) receive the response signals and the hyper pixels from the controller; (ii) detect one or more misaligned layers in each cell and a misalignment type for each of the one or more misaligned layers based upon the response signals or the hyper pixels; and (iii) calculate a misalignment score based upon the response signals or the hyper pixels, the misalignment score indicating a level of misalignment of the one or more layers in each battery cell.

Clause 2. The inspection system of any clause or example herein, in particular, Clause 1, wherein:
the inspection system is for performing ultrasound interrogation sessions upon battery cells, the inspection system; and/or
the inspection system performs an action associated with each battery cell based upon the misalignment score.

Clause 3. The inspection system of any clause or example herein, in particular, any one of Clauses 1-2, wherein the controller receives the misalignment score from the processing system, and wherein the action performed by the inspection system for each battery cell based on the misalignment score includes the controller performing one or more of:
presenting the misalignment score to a display of the controller;
presenting a first color to the display when the misalignment score exceeds a threshold value associated with non-misalignment, and presenting a second color that is different than the first color to the display when the misalignment score is less than the threshold value; and including the misalignment score in a message and sending the message via email or text message to a user device of an operator of the inspection system.

Clause 4. The inspection system of any clause or example herein, in particular, any one of Clauses 1-3, wherein the controller receives the misalignment score from the processing system, and wherein the action performed by the inspection system for each battery cell based on the misalignment score includes the controller instructing a gantry of the transport module to move each battery cell to either a pass bin or a fail bin based upon the misalignment score.

Clause 5. The inspection system of any clause or example herein, in particular, any one of Clauses 1-4, wherein when the transport module is configured to move each battery cell relative to the ultrasound transducers, one, some, or all of the ultrasound transducers are non-contact transducers, and the ultrasound transducers and each battery cell are immersed in an electrically non-conducting fluid during the transmission of the ultrasound and the detection of the ultrasound.

Clause 6. The inspection system of any clause or example herein, in particular, any one of Clauses 1-5, wherein when the transport module is configured to move the ultrasound transducers relative to each battery cell, one, some, or all of the ultrasound transducers are contact transducers including a couplant located between faces of the ultrasound transducers and either a surface of the battery cell or a surface of a housing within which each battery cell is housed.

Clause 7. The inspection system of any clause or example herein, in particular, any one of Clauses 1-6, wherein at least one misalignment type is a short anode misalignment or a short cathode misalignment.

Clause 8. The inspection system of any clause or example herein, in particular, any one of Clauses 1-7, wherein at least one misalignment type is a long anode misalignment or a long cathode misalignment.

Clause 9. The inspection system of any clause or example herein, in particular, any one of Clauses 1-8, wherein at least one misalignment type is a folded anode misalignment or a folded cathode misalignment.

Clause 10. The inspection system of any clause or example herein, in particular, any one of Clauses 1-9, wherein at least one misalignment type is a folded electrode assembly misalignment.

Clause 11. The inspection system of any clause or example herein, in particular, any one of Clauses 1-10, wherein the processing system includes a machine learning model that generates a predicted misalignment score as output, in response to the machine learning model receiving as input the response signals or the hyper pixels of each battery cell obtained during the interrogation session of each battery cell.

Clause 12. The inspection system of any clause or example herein, in particular, Clause 11, wherein the machine learning model is previously trained to predict misalignment of the one or more layers in the battery cells and the type of misalignment using training data, the training data including response signals and/or hyper pixels of reference battery cells obtained from interrogation sessions of the reference battery cells.

Clause 13. The inspection system of any clause or example herein, in particular, any one of Clauses 1-12, wherein one, some, or all of the ultrasound transducers are configured to focus the transmitted ultrasound signals into a focused beam at the target points.

Clause 14. The inspection system of any clause or example herein, in particular, any one of Clauses 1-13, wherein one, some, or all of the ultrasound transducers include a lens attached to a face of the transducers to focus the transmitted ultrasound signals into a focused beam at the target points.

Clause 15. The inspection system of any clause or example herein, in particular, any one of Clauses 1-14, wherein faces of one, some, or all of the ultrasound transducers are formed to focus the transmitted ultrasound signals into a focused beam at the target points.

Clause 16. The inspection system of any clause or example herein, in particular, any one of Clauses 1-15, wherein the ultrasound transducers are included in an array of transducers, and the array focuses the transmitted ultrasound signals into a focused beam at the target points.

Clause 17. The inspection system of any clause or example herein, in particular, any one of Clauses 1-16, wherein the processing system is located on a network that is remote to the controller and the SDM.

Clause 18. A method for operating the inspection system of any clause or example herein, in particular, any one of Clauses 1-17.

Clause 19. A method comprising:
interrogating each battery cell by transmitting ultrasound signals into each battery cell at target points, detecting ultrasound reflected from each battery cell at each of the target points, and generating response signals from the detected ultrasound at each of the target points;
creating a hyper pixel for each target point, wherein each hyper pixel includes a representation of the response signals at each target point;
detecting one or more misaligned layers and a misalignment type for each of the one or more misaligned layers in each cell based upon the response signals or the hyper pixels;
calculating a misalignment score based upon the response signals or the hyper pixels for each target point, the misalignment score indicating a level of misalignment of the one or more layers in each battery cell.

Clause 20. The method of any clause or example herein, in particular, any one of Clauses 18-19, wherein:
the method is for an inspection system that performs ultrasound interrogation sessions upon battery cells, and/or
the method further comprises performing an action associated with each battery cell based upon the misalignment score.

Clause 21. The method of any clause or example herein, in particular, any one of Clauses 18-20, wherein performing an action associated with each battery cell based upon the misalignment score comprises performing one or more of:
presenting the misalignment score to a display of the inspection system;
presenting a first color to the display when the misalignment score exceeds a threshold value associated with non-misalignment, and presenting a second color that is different than the first color to the display when the misalignment score is less than the threshold value; and
including the misalignment score in a message and sending the message via email or text message to a user device of an operator of the inspection system.

Clause 22. The method of any clause or example herein, in particular, any one of Clauses 18-21, wherein performing an action associated with each battery cell based upon the misalignment score comprises moving each battery cell to either a pass bin or a fail bin based upon the misalignment score.

Clause 23. The method of any clause or example herein, in particular, any one of Clauses 18-22, further comprising focusing the transmitted ultrasound signals into a focused beam at one or more of the target points.

Clause 24. The method of any clause or example herein, in particular, any one of Clauses 18-23, wherein calculating a misalignment score based upon the response signals or the hyper pixels for each target point comprises using a machine learning model to generate a predicted misalignment score as output, in response to the machine learning model receiving, as input, the response signals of each battery cell and/or the hyper pixels of each battery cell during the interrogation session of each battery cell.

Clause 25. The method of any clause or example herein, in particular, Clause 24, further comprising training the machine learning model to predict misalignment of the one or more layers in the battery cells and the type of misalignment using, or based at least in part on, training data, prior to calculating the misalignment score for each battery cell, the training data including the response signals and/or the hyper pixels of reference battery cells obtained from interrogation sessions of the reference battery cells.

Clause 26 The method of any clause or example herein, in particular, any one of Clauses 18-25, further comprising:
extracting one or more ultrasound features from the response signals and/or the hyper pixels obtained for each battery cell, the one or more ultrasound features having been experimentally shown to detect layer misalignment of the one or more layers in the battery cells,
wherein calculating a misalignment score based upon the response signals or the hyper pixels for each target point comprises using a machine learning model to generate a predicted misalignment score as output, in response to the machine learning model receiving, as input, the one or more ultrasound features extracted for each battery cell.

### Conclusion

Although energy storage devices (e.g., battery cells), components, and configuration have been illustrated in the figures and discussed in detail herein, embodiments of the disclosed subject matter are not limited thereto. Indeed, one of ordinary skill in the art will readily appreciate that different energy storage devices, components, or configurations can be selected and/or components added to provide the same effect. In practical implementations, embodiments may include additional components or other variations beyond those illustrated. Accordingly, embodiments of the disclosed subject matter are not limited to the particular batteries, components, and configurations specifically illustrated and described herein.

Any of the features illustrated or described herein, for example, with respect to FIGS. 1-22 and Clauses 1-26, can be combined with any other feature illustrated or described herein, for example, with respect to FIGS. 1-22 and Clauses 1-26 to provide systems, devices, methods, and embodiments not otherwise illustrated or specifically described herein. All features described herein are independent of one another and, except where structurally impossible, can be used in combination with any other feature described herein.

It will also be recognized by those skilled in the art that, while the invention has been described above in terms of examples and embodiments, it is not limited thereto. Various features and aspects of the above-described embodiments may be used individually or jointly. In view of the many possible embodiments to which the principles of the disclosed technology may be applied. it should be recognized that the illustrated embodiments are only examples and should not be taken as limiting the scope of the disclosed technology. Rather. the scope is defined by the following claims. Applicant therefore claims all that comes within the scope and spirit of these claims.

1. An inspection system for performing ultrasound interrogation sessions upon battery cells, the inspection system comprising:
ultrasound transducers configured to:
receive ultrasound excitation signals;
transmit ultrasound at target points of each battery cell, in response to receiving the excitation signals;
detect ultrasound reflected from each battery cell in response to the transmission of the ultrasound at the target points; and
generate response signals based upon the detected ultrasound at the target points;
a transport module that is configured to either move each battery cell relative to the ultrasound transducers, or to move the ultrasound transducers relative to each battery cell, during the ultrasound interrogation of each battery cell;
a controller and a signal drive and acquisition system (SDM), wherein the SDM is configured to generate and send the excitation signals to the ultrasound transducers, to receive the response signals associated with the detected ultrasound at the target points from the ultrasound transducers, and to forward the response signals to the controller; and wherein the controller creates a hyper pixel for the response signals at each of the target points, each hyper pixel including a representation of the response signals generated for each of the target points; and
a processing system configured to receive the response signals and the hyper pixels from the controller, to detect one or more misaligned layers in each cell and a misalignment type for each of the one or more misaligned layers based upon the response signals or the hyper pixels, and to calculate a misalignment score based upon the response signals or the hyper pixels, the misalignment score indicating a level of misalignment of the one or more layers in each battery cell,
wherein the inspection system performs an action associated with each battery cell based upon the misalignment score.

2. The inspection system of claim 1, wherein the controller receives the misalignment score from the processing system, and the action performed by the inspection system for each battery cell based on the misalignment score includes the controller performing one or more of:
presenting the misalignment score to a display of the controller;
presenting a first color to the display when the misalignment score exceeds a threshold value associated with non-misalignment, and presenting a second color that is different than the first color to the display when the misalignment score is less than the threshold value; and
including the misalignment score in a message and sending the message via email or text message to a user device of an operator of the inspection system.

3. The inspection system of claim 1, wherein the controller receives the misalignment score from the processing system, and the action performed by the inspection system for each battery cell based on the misalignment score includes the controller instructing a gantry of the transport module to move each battery cell to either a pass bin or a fail bin based upon the misalignment score.

4. The inspection system of claim 1, wherein:
the transport module is configured to move each battery cell relative to the ultrasound transducers,
the ultrasound transducers are non-contact transducers, and
the ultrasound transducers and each battery cell are immersed in an electrically non-conducting fluid during the transmission of the ultrasound and the detection of the ultrasound.

5. The inspection system of claim 1, wherein:
the transport module is configured to move the ultrasound transducers relative to each battery cell, and
the ultrasound transducers are contact transducers including a couplant located between faces of the ultrasound transducers and either a surface of the battery cell or a surface of a housing within which each battery cell is housed.

6. The inspection system of claim 1, wherein the misalignment type is one of a short anode misalignment, a short cathode misalignment, a long anode misalignment, a long cathode misalignment, a folded anode misalignment, a folded cathode misalignment, and a folded electrode assembly misalignment.

7. The inspection system of claim 1, wherein the processing system includes a machine learning model that generates a predicted misalignment score as output, in response to the machine learning model receiving, as input, the response signals or the hyper pixels of each battery cell obtained during the interrogation session of each battery cell.

8. The inspection system of claim 7, wherein the machine learning model is previously trained to predict misalignment of the one or more layers in the battery cells and the type of misalignment using training data, the training data including response signals and/or hyper pixels of reference battery cells obtained from interrogation sessions of the reference battery cells.

9. The inspection system of claim 1, wherein the ultrasound transducers are configured to focus the transmitted ultrasound signals into a focused beam at the target points.

10. The inspection system of claim 9, wherein the ultrasound transducers include a lens attached to a face of the transducers to focus the transmitted ultrasound signals into a focused beam at the target points.

11. The inspection system of claim 9, wherein faces of the ultrasound transducers are formed to focus the transmitted ultrasound signals into a focused beam at the target points.

12. The inspection system of claim 9, wherein the ultrasound transducers are included in an array of transducers, and the array focuses the transmitted ultrasound signals into a focused beam at the target points.

13. The inspection system of claim 1, wherein the processing system is located on a network that is remote to the controller and the SDM.

14. A method for an inspection system that performs ultrasound interrogation sessions upon battery cells, the method comprising:
interrogating each battery cell by transmitting ultrasound signals into each battery cell at target points, detecting ultrasound reflected from each battery cell at each of the target points, and generating response signals from the detected ultrasound at each of the target points;
creating a hyper pixel for each target point, wherein each hyper pixel includes a representation of the response signals at each target point;
detecting one or more misaligned layers and a misalignment type for each of the one or more misaligned layers in each cell based upon the response signals or the hyper pixels;
calculating a misalignment score based upon the response signals or the hyper pixels for each target point, the misalignment score indicating a level of misalignment of the one or more layers in each battery cell; and
performing an action associated with each battery cell based upon the misalignment score.

15. The method of claim 14, wherein the performing an action associated with each battery cell based upon the misalignment score comprises performing one or more of:
presenting the misalignment score to a display of the inspection system;
presenting a first color to the display when the misalignment score exceeds a threshold value associated with non-misalignment, and presenting a second color that is different than the first color to the display when the misalignment score is less than the threshold value; and
including the misalignment score in a message and sending the message via email or text message to a user device of an operator of the inspection system.

16. The method of claim 14, wherein the performing an action associated with each battery cell based upon the misalignment score comprises moving each battery cell to either a pass bin or a fail bin based upon the misalignment score.

17. The method of claim 14, further comprising focusing the transmitted ultrasound signals into respective focused beams at the target points.

18. The method of claim 14, wherein the calculating a misalignment score based upon the response signals or the hyper pixels for each target point comprises a machine learning model generating a predicted misalignment score as output, in response to the machine learning model receiving, as input, the response signals of each battery cell and/or the hyper pixels of each battery cell during the interrogation session of each battery cell.

19. The method of claim 18, further comprising:
training the machine learning model to predict misalignment of the one or more layers in the battery cells and the type of misalignment using training data, prior to calculating the misalignment score for each battery cell,
wherein the training data includes the response signals and/or the hyper pixels of reference battery cells obtained from interrogation sessions of the reference battery cells.

20. The method of claim 14, further comprising:
extracting one or more ultrasound features from the response signals and/or the hyper pixels obtained for each battery cell, the one or more ultrasound features having been experimentally shown to detect layer misalignment of the one or more layers in the battery cells,
wherein calculating a misalignment score based upon the response signals or the hyper pixels for each target point comprises a machine learning model generating a predicted misalignment score as output, in response to the machine learning model receiving, as input, the one or more ultrasound features extracted for each battery cell.
